(19) United States
(12) Patent Application Publication
(10) Pub. No.: US 2010/0008706 A1
(43) Pub. Date: Jan. 14, 2010

(54) CLEANING DEVICE AND IMAGE FORMING APPARATUS

(76) Inventors: Kenji Sugiura, Yokohama-shi (JP); Osamu Naruse, Yokohama-shi (JP); Hidetoshi Yano, Yokohama-shi (JP); Naomi Sugimoto, Kawasaki-shi (JP); Hiroki Nakamatsu, Fujisawa-shi (JP); Satoshi Muramatsu, Yokohama-shi (JP)

Correspondence Address: DICKSTEIN SHAPIRO LLP, 1825 EYE STREET NW, Washington, DC, 20006-5403, US

(21) Appl. No.: 12/490,742

(22) Filed: Jun. 24, 2009

(30) Foreign Application Priority Data
Jul. 9, 2008 (JP) 2008-179621

(51) Int. Cl. G03G 21/00

(52) U.S. Cl. 399/350; 399/353

(57) ABSTRACT

A cleaning device used for removing toner particles remaining on an image bearing member, including a plurality of brush rollers capable of coming into contact with the image bearing member, the brush rollers being disposed around the image bearing member in a row in a direction in which the image bearing member is moved, wherein one of the brush rollers includes brush fibers each containing a conductive agent dispersed homogeneously therein or only in its surface layer, wherein another brush roller includes oblique brush fibers, looped brush fibers, or both of them, each brush fiber containing the conductive agent localized in a center portion thereof without being dispersed in its surface layer, and wherein the oblique brush fibers are obliquely provided in the another brush roller so that tip portions thereof are curled on the image bearing member in a direction in which the image bearing member is moved.

### BACKGROUND OF THE INVENTION

1. Field of the Invention

The present invention relates to a cleaning device and an image forming apparatus, more specifically, to a cleaning device which is configured to clean small, spherical toner particles such as polymerized toner particles.

2. Description of the Related Art

As has been known well, image forming apparatuses (e.g., copiers and printers), in a charging step, uniformly charge photoconductors serving as a latent image bearing member, and then form a latent electrostatic image based on, for example, image information through an optical writing process.

The latent electrostatic image formed on the photoconductor is visualized with toner supplied from a developing device, and then the formed visible image is transferred to a recording medium (e.g., a paper sheet) or an intermediate transfer member using a transfer unit. When the visible image is directly transferred to the recording medium, a monochromatic image is often intended to be formed in many cases. When the visible image is transferred to the intermediate transfer member, a multi-color image (e.g., a full color image) is intended to be formed. Also, there are a case where color images are sequentially transferred onto the intermediate member to form a composite image, and the thus-formed composite image is transferred onto the recording medium at one time to form a multi-color image; and a case where a transfer belt carries and conveys the recording medium to image forming stations for color toners, and color images are transferred onto the recording medium in a superposed manner to form a multi-color image. In both cases, the final product is a toner image transferred onto the recording medium.

The image bearing member encompasses not only the photoconductor but also the intermediate transfer member onto which images formed in image forming stations for color toners are transferred.

The photoconductor or intermediate transfer member, from which a toner image(s) formed with a developing device(s) has been transferred, is cleaned by removing toner particles remaining thereon (e.g., remaining toner particles after transfer (post-transfer remaining toner particles)). This cleaning is performed for preventing remaining tone particles from being transferred onto the subsequent recording media and causing background smear thereof.

In view of this, conventionally, blade cleaning is often employed for cleaning the remaining toner particles.

In blade cleaning, a blade is brought into contact with a member to be cleaned to stop the remaining toner particles from being further moved on the member to be cleaned, to thereby scrape off the remaining toner particles from the member to be cleaned.

Meanwhile, in recent years, increased demand has arisen for a high-quality image of high resolution. Thus, rather than conventionally used pulverized toner particles, polymerized toner particles have been increasingly used since their particle size can be small and their shape can be truly spherical.

The spherical polymerized toner particles are often used, since they are advantageously increased in transfer rate and thus, the amount of post-transfer remaining toner particles to be disposed of is reduced. The reason for this is described as follows.

Toner particles are supplied, in a developing step, to a latent electrostatic image formed on an image bearing member (e.g., a photoconductor) with being given a developing bias.

The thus-supplied toner particles are attached to the image bearing member by the action of the developing bias and an electrical potential of the latent electrostatic image. And, they adhere to the image bearing member surface mainly by a mirror image force and a van der Waals force. The intensity of the mirror image force depends greatly on the amount of charges and the interdistance therebetween.

Conventionally used pulverized toner particles each have irregularities on their surfaces, and their convex portions are intensively frictionally charged. In contrast, polymerized toner particles each have smooth, (almost) spherical surfaces and the surfaces are uniformly charged. Here, such pulverized toner particles come into contact with the image bearing member at their convex portions. Thus, a large amount of charges exist in a region where the toner particles are very close to the image bearing member, increasing the mirror image force acting therebetween. In contrast, spherical toner particles (e.g., polymerized toner particles) virtually come into point contact with the image bearing member, and adjacent regions to the contact points have a small amount of charges. Thus, the mirror image force acting between the polymerized toner particles and the image bearing member is smaller than that acting between the pulverized toner particles and the image bearing member.

Meanwhile, as described above, a large amount of the pulverized toner particles come into contact with the image bearing member at their convex portions and thus, the van der Waals force acting therebetween is considerably increased. In contrast, as described above, the polymerized toner particles have smooth, spherical surfaces and thus, virtually come into point contact with the image bearing member. Thus, the van der Waals force acting between the polymerized toner particles and the image bearing member is smaller than that acting between the pulverized toner particles and the image bearing member.

From the viewpoint of the above, almost spherical polymerized toner particles have a small adhesive force to the photoconductor; i.e., have a small mirror image force/van der Waals force acting thereon. Thus, the amount of the post-transfer remaining toner particles can be reduced to decrease the amount of toner particles consumed, which is economically advantageous.

However, when the post-transfer remaining toner particles are cleaned, such almost spherical polymerized toner particles, among others, small, truly spherical polymerized toner particles are likely to run through between a blade and the image bearing member surface. Thus, when the small, spherical toner particles are cleaned by the blade, it must be pressed against the image bearing member at a high pressing force (for example, at a linear pressure of 100 gf/cm or higher) to stop the toner particles from being further conveyed.

Pressing of the blade against the image bearing member surface accelerates ablation thereof.

Specifically, when a cleaning blade is pressed against a photoconductor drum (φ30) at a linear pressure of 20 gf/cm—at which the service lives of these members usually extremely become short due to, for example, ablation thereof—, the service life of the photoconductor drum (i.e., time required that about ⅓ of the photoconductive layer be ablated) is about 100 kp, and that of the cleaning blade (i.e., time required that cleaning failures occur due to ablation thereof) is about 120 kp. But, as described above, when the cleaning blade is pressed against the photoconductor drum at a high pressing force (i.e., at a linear pressure of 100 gf/cm), the service life of the photoconductor drum is shorten to about 20 kp and that of the cleaning blade is shorten to about 20 kp.

Moreover, when a blade is pressed against an image bearing member at a high pressing force, a motor torque for driving the image bearing member must be increased, which is disadvantageous.

In view of this, various attempts have been made to clean highly spherical, small toner particles without giving damage on an image bearing member, and Japanese Patent Application Laid-Open (JP-A) Nos. 2005-265907 and 2005-17764 disclose methods in which an electrostatic brush roller is used to adsorb toner particles by the action of an electrostatic force.

The methods disclosed in the above patent literatures are performed based on the following configuration. Specifically, rotatable brush rollers (i.e., cleaning brushes), each being given a cleaning bias, are provided in a row around an image bearing member having remaining toner particles thereon in a direction in which the image bearing member is moved so as to be in contact therewith. Also, recovering rollers are disposed so as to be in contact with the brushes and are given a recovering bias. The toner particles which have been transferred from the image bearing member to the brush roller are recovered utilizing an electrical potential difference between the cleaning and recovering biases. In one configuration disclosed therein, the brush rollers are given bias voltages having different polarities so as to clean a mixture of positive and negative toner particles present on the image bearing member (see FIG. 38).

Here, the principle of electrostatic cleaning disclosed in the above patent literatures is described as follows.

FIG. 39 illustrates a toner transfer model. In this figure, Vb denotes an electrical potential of brush fibers of a brush roller, and Vr denotes an electrical potential of a recovering roller surface. A toner particle has “negative” charges, and Q1 denotes a charge amount of the toner particle on an OPC, Q2 denotes a charge amount of the toner particle on brush fibers, and Q3 denotes a charge amount of the toner particle on a recovering roller. And, the toner particle is transferred by the action of an electrical field generated by the electrical potential difference between V_{opc} and Vb or Vb and Vr. In FIG. 39, a “primary cleaning” refers to a transfer of the toner particle from the photoconductor onto the brush fibers, and a “secondary cleaning” refers to a transfer of the toner particle from the brush fibers onto the recovering roller.

In the above-described methods in which toner particles are electrostatically transferred from a cleaning brush onto a recovering roller utilizing a potential difference therebetween, a mixture of positive and negative toner particles can be recovered from an image bearing member using an upstream brush roller and a downstream brush roller which are given voltages having different polarities.

### BRIEF SUMMARY OF THE INVENTION

In the configurations disclosed in the above patent literatures, brush fibers of a brush roller charge some of the toner particles transferred thereonto, so that the toner particles have the same polarity as the brush fibers. The resultant toner particles may adhere again to the image bearing member through repulsion by the brush fibers.

The toner particles, which have been transferred again to the image bearing member from the brush roller located upstream in a direction in which the image bearing member is moved, can be transferred onto a downstream brush roller which is given a cleaning bias having an opposite polarity to that applied to the upstream brush roller. But, if the similar phenomenon arises in downstream cleaning brush fibers, the toner particles which have adhered again to the image bearing member cannot be recovered, causing cleaning failures of the image bearing member.

The reason why toner particles recovered on brush fibers adhere again to the image bearing member is that tone particles are brought into contact with a conductive agent exposed on brush fiber surfaces, and then charges are injected into the toner particles.

Meanwhile, toner particles remaining on an image bearing member may contain non-charged toner particles, in addition to positively-charged and negatively-charged toner particles as described above.

The non-charged toner particles cannot be removed by a brush roller having an electrostatic cleaning mechanism based on application of a bias voltage, potentially causing cleaning failures.

Presumably, using the configurations disclosed in the above patent literatures where the upstream brush roller is set to have an opposite polarity to that of the downstream brush roller, the upstream brush roller injects charges into the non-charged toner particles, and then the resultant toner particles can be removed by the downstream brush roller.

But, when brush fibers used for charge injection into tone particles are configured that their conductive agents are brought into contact with the toner particles, the above-described problem—re-adhesion of the toner particles to the image bearing member—may not be completely solved.

In view of the existing problems involved by conventional cleaning devices based on electrostatic cleaning, an object of the present invention is to provide a cleaning device which can remove non-charged toner particles while preventing re-adhesion of remaining toner particles on an image bearing member; and an image forming apparatus.

The present invention provides the following in order to achieve the above object.

<1> A cleaning device used for removing toner particles remaining on an image bearing member, the cleaning device including:

a plurality of brush rollers capable of coming into contact with the image bearing member, the brush rollers being disposed around the image bearing member in a row in a direction in which the image bearing member is moved,

wherein one of the brush rollers includes brush fibers each containing a conductive agent dispersed homogeneously therein or dispersed only in a surface layer thereof,

wherein another brush roller includes oblique brush fibers, looped brush fibers, or both the oblique brush fibers and the looped brush fibers, each brush fiber containing the conductive agent localized in a center portion thereof without being dispersed in a surface layer thereof, and

wherein the oblique brush fibers are obliquely provided in the another brush roller so that tip portions thereof are curled on the image bearing member in a direction in which the image bearing member is moved.

<2> The cleaning device according to <1> above, wherein the another brush roller includes the oblique brush fibers.

<3> The cleaning device according to <1> above, wherein the another brush roller includes-the looped brush fibers.

<4> The cleaning device according to any one of <1> to <3> above, further including rollers provided respectively for the plurality of brush rollers so as to be in contact therewith, wherein the roller which is in contact with the another brush roller is provided with an insulative surface layer.

<5> The cleaning device according to any one of <1> and <2> above, wherein the toner particles remaining on the image bearing member are adjusted to have a shape factor 1 (SF-1) of 100 to 150.

<6> An image forming apparatus including:

the cleaning device according to any one of <1> to <5> above.

<7> The image forming apparatus according to <6> above, further including photoconductors and image forming sections capable of forming images of different colors, the photoconductors being provided respectively in the image forming sections, wherein the cleaning device is provided for each of the photoconductors.

<8> The image forming apparatus according to <6> above, further including an intermediate transfer member and image forming sections capable of forming images of different colors, wherein the images formed in the image forming sections are sequentially transferred onto the intermediate transfer member, and wherein the cleaning device is provided for the intermediate transfer member.

<9> The image forming apparatus according to <6> above, further including a belt member and image forming sections capable of forming images of different colors, the image forming sections being provided around the belt member, wherein the belt member conveys a recording medium to the image forming sections, and wherein the cleaning device is provided for the belt member.

<10> The image forming apparatus according to <7> above, wherein each of the photoconductors contains a filler dispersed therein.

<11> The image forming apparatus according to <7> above, wherein each of the photoconductors is an organic photoconductor having a surface layer reinforced with a filling agent, an organic photoconductor containing a crosslinkable charge transport material, or a photoconductor having a surface layer reinforced with a filling agent and containing a crosslinkable charge transport material.

<12> The image forming apparatus according to <7> above, wherein each of the photoconductors is an amorphous silicon photoconductor.

<13> The image forming apparatus according to any one of <6> and <10> to <12> above, further including a process cartridge, wherein the process cartridge integrally houses any of the image bearing member or the photoconductor, a charging unit, a developing unit and the cleaning device, and wherein the charging unit, the developing unit and the cleaning device are used for image forming processing with respect to the image bearing member or the photoconductor.

<14> The image forming apparatus according to any one of <6> to <13> above, wherein the cleaning device further includes a recovering roller capable of coming into contact with the brush rollers, and a blade which is provided so as to be in contact with the recovering roller and to scrape off the toner particles thereon, and wherein the blade is provided with a coating layer having ablation resistance at an edge surface where the blade is in contact with the recovering roller.

The cleaning device of the present invention uses a brush roller having brush fibers each containing a conductive agent dispersed homogeneously therein or dispersed only in a surface layer thereof, and another brush roller having oblique brush fibers each containing a conductive agent localized in a center portion thereof, the oblique brush fibers being obliquely provided so that tip portions thereof are curled on an image bearing member in a direction in which the image bearing member is moved. Thus, this cleaning device can inject charges into non-charged toner particles using the brush roller so as to have a polarity as desired. The toner particles resulting from the non-charged toner particles can be recovered by the another brush roller. In addition, the another brush roller does not come into direct contact with the toner particles, preventing the recovered toner particles from re-adhering to the image bearing member as a result of charge injection thereinto.

### BRIEF DESCRIPTION OF THE DRAWINGS

FIG. 1 is a schematic, explanatory view of an image forming apparatus containing a cleaning device of the present invention.

FIG. 2A is a schematic illustration used for describing a shape factor of toner particles used in a developing device of the image forming apparatus shown in FIG. 1.

FIG. 2B is a schematic illustration used for describing a shape factor of toner particles used in a developing device of the image forming apparatus shown in FIG. 1.

FIG. 3 is a graph of a relationship between a charge amount distribution of toner and changes in environmental factors.

FIG. 4 is a graph of a charge amount distribution of toner under high-temperature, high-humidity conditions.

FIG. 5 is a graph of a charge amount distribution of toner under low-temperature, low-humidity conditions.

FIG. 6 is a schematic, explanatory view of an image forming apparatus containing brush rollers having upright brush fibers.

FIG. 7 is a cross-sectional view of a brush fiber containing a conductive agent dispersed in its surface.

FIG. 8 is a cross-sectional view of a brush fiber containing a conductive agent homogeneously dispersed therein.

FIG. 9 is a cross-sectional view of a brush fiber containing a conductive agent localized in its center portion.

FIG. 10 is a cross-sectional view of a brush fiber containing a conductive agent dispersed in its center portion as shown in FIG. 9 but having a different structure from that shown in FIG. 9.

FIG. 11 is a cross-sectional view used for describing a problem involved by an upright brush fiber.

FIG. 12 is a schematic, explanatory view of an image forming apparatus which is the same as that shown in FIG. 6, except that some members are removed for investigating whether or not charges are injected into remaining toner particles.

FIG. 13 is a graph showing Experimental Results in relation to an ID for the amount of toner remaining after cleaning (a post-cleaning toner ID) obtained using image forming apparatuses shown in FIGS. 12, 14 and 16.

FIG. 14 is a schematic, explanatory view of an image forming apparatus used for investigating whether or not brush fibers inject charges into toner particles.

FIG. 15A is a cross-sectional view of an obliquely provided brush fiber which is in contact with a toner particle and a photoconductor.

FIG. 15B is a cross-sectional view of a looped brush fiber which is in contact with a toner particle and a photoconductor.

FIG. 16 is a schematic, explanatory view of an image forming apparatus which is the same as that shown in FIG. 14, except that essential parts are modified for investigating whether or not brush fibers inject charges into toner particles.

FIG. 17 is a graph of post-cleaning toner IDs obtained by using, in a cleaning device of the present invention, a recovering roller whose surface layer is made of SUS, PVDF (log Ω=12) or fluorine coating (log Ω=8), wherein black solid rhombi correspond to those obtained by using SUS, black solid squares those obtained by using PVDF, and black solid triangles those obtained by using fluorine coating.

FIG. 18 is a graph of post-cleaning toner IDs obtained by using, in a cleaning device of the present invention, a recovering roller whose surface layer is made of a material partially different from those shown in FIG. 17, wherein black solid rhombi correspond to those obtained by using SUS, and black solid squares those obtained by using acrylic coating.

FIG. 19 is a schematic view of an image forming apparatus containing a cleaning device of the present invention, wherein first and second brush rollers have oblique brush fibers.

FIG. 20 is a schematic view of a configuration employed for supplying charges to a brush roller.

FIG. 21 is a schematic view of a configuration which is virtually the same as that shown in FIG. 20, except that the brush roller has looped brush fibers.

FIG. 22 is a schematic view of a configuration which is the same as that shown in FIG. 20, except that no charges are supplied to the recovering roller.

FIG. 23 is an exemplary, schematic view of an image forming apparatus containing a cleaning device of the present invention which uses medium resistance recovering rollers.

FIG. 24 is an exemplary, schematic view of an image forming apparatus which is the same as that shown in FIG. 23, except that one of the medium resistance recovering rollers is changed to an insulative recovering roller.

FIG. 25 is an exemplary, schematic view of a configuration used for observing a change in electrical potential when no charges are supplied to a recovering roller used in a cleaning device of the present invention.

FIG. 26 is a graph of a change in electrical potential obtained using the configuration shown in FIG. 25, wherein a solid line corresponds to a change in brush fiber tip electrical potential, and a dotted line a change in recovering roller surface electrical potential.

FIG. 27 shows a toner transfer model used for describing a mechanism in which a toner particle is transferred depending on the change in electrical potential shown in FIG. 25.

FIG. 28 is an exemplary, schematic view of a configuration used for observing a change in electrical potential when charges are supplied to a recovering roller used in a cleaning device of the present invention.

FIG. 29 is a graph of changes in electrical potential obtained using the configuration shown in FIG. 28, wherein an upper wavy line indicates a recovering roller surface electrical potential Vr, a lower wavy line indicates a brush fiber tip electrical potential Vb, the difference between Vb and 0 corresponds to V1, and the difference between Vr and Vb corresponds to V2, these reference characters being shown in FIG. 39.

FIG. 30 shows a toner transfer model used for describing a mechanism in which a toner particle is transferred when no charges are supplied to brush fibers of a brush roller contained in a cleaning device of the present invention.

FIG. 31A is an exemplary view of a photoconductor used in an image forming apparatus of the present invention, the photoconductor being a product at a production step.

FIG. 31B is an exemplary view of a photoconductor used in an image forming apparatus of the present invention, the photoconductor being a product at a production step.

FIG. 31C is an exemplary view of a photoconductor used in an image forming apparatus of the present invention, the photoconductor being a product at a production step.

FIG. 31D is an exemplary view of a photoconductor used in an image forming apparatus of the present invention, the photoconductor being a product at a production step.

FIG. 32A shows structural formula (I) which a hole transport compound used in a photoconductor of an image forming apparatus of the present invention has.

FIG. 32B shows structural formula (II) which a hole transport compound used in a photoconductor of an image forming apparatus of the present invention has.

FIG. 33A is one configuration of a charging unit used in an image forming apparatus of the present invention.

FIG. 33B is another configuration of a charging unit used in an image forming apparatus of the present invention.

FIG. 33C is still another configuration of a charging unit used in an image forming apparatus of the present invention.

FIG. 33D is yet another configuration of a charging unit used in an image forming apparatus of the present invention.

FIG. 34 is an explanatory, schematic view of an image forming apparatus to which a cleaning device of the present invention is applied.

FIG. 35 is an explanatory, schematic view of another image forming apparatus to which a cleaning device of the present invention is applied.

FIG. 36 is an explanatory, schematic view of still another image forming apparatus to which a cleaning device of the present invention is applied.

FIG. 37 is an explanatory, schematic view of a process cartridge used in an image forming apparatus of the present invention.

FIG. 38 is a graph of a polarity of toner particles remaining on an image bearing member.

FIG. 39 shows a toner transfer model used for describing the principle of electrostatic cleaning.

### DETAILED DESCRIPTION OF THE INVENTION

With reference to the drawings, next will be described a best mode for carrying out the present invention.

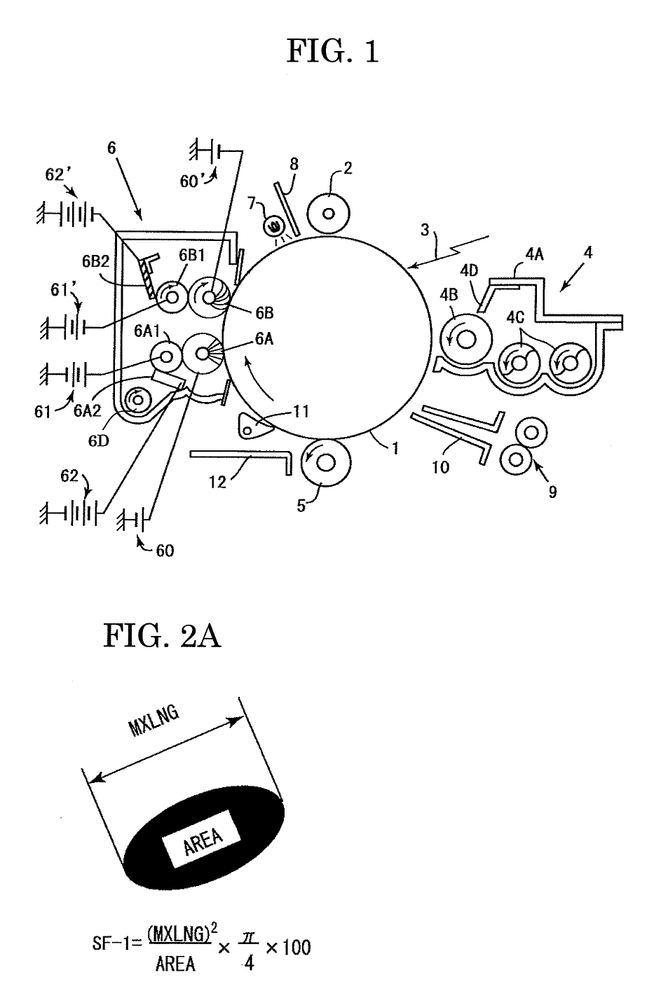

FIG. 1 is a schematic, explanatory view of an image forming apparatus containing a cleaning device of the present invention.

The image forming apparatus shown in FIG. 1 includes a photoconductor drum 1 serving as an image bearing member, a charging unit 2, a writing device 3 (in FIG. 1, only a light path is illustrated), a developing device 4, a transfer device 5, a cleaning device 6 of the present invention, a quenching lamp 7 and a light-shielding plate 8. The photoconductor drum 1 is configured to be rotated in a direction indicated by an arrow in FIG. 1. The charging unit 2, the writing device 3, the developing device 4, the transfer device 5, the cleaning device 6, the quenching lamp 7 and the light-shielding plate 8 are provided in order to perform image forming processing and disposed around the photoconductor drum 1 in a direction in which it is rotated.

The charging unit 2 is a non-contact roller which is disposed proximately to the photoconductor drum 1. The developing device 4 contains a developing sleeve 4B to which a developing bias is applied from an unillustrated power source. The transfer device 5 is a roller disposed so as to face the photoconductor drum 1, and a recording paper fed by an unillustrated paper-feeding device is sandwiched between the roller and the photoconductor drum. The roller is configured to be given a transfer bias from an unillustrated power source upon transfer. In the vicinity of a position where image transfer is performed by the transfer device 5 is disposed resist rollers 9 for adjusting the timing at which a recording paper having been fed by the unillustrated paper-feeding device is fed, and feeding guides 10 for conveying the recording paper to the position.

The developing device 4 has, in a developing housing 4A, the developing sleeve 4B facing the photoconductor drum 1, feeding rollers 4C for feeding a developer frictionally charged by stirring/mixing to the developing sleeve, and a doctor blade 4D for controlling a thickness of the developer carried on the developing sleeve 4B.

The cleaning device 6 has, in a housing, brush rollers 6A and 6B whose brush fibers are in contact with a surface of the photoconductor drum 1 and which are disposed around the photoconductor drum 1 in a direction in which it is moved. For the sake of convenience, the brush roller denoted by reference numeral 6A refers to a first brush roller, and that denoted by reference character 6B refers to a second brush roller.

The first and second brush rollers 6A and 6B are provided with recovering rollers 6A1 and 6B1 such that the recovering rollers are in contact with almost opposite surfaces to contact surfaces between the brush rollers and the photoconductor drum 1. Also, the recovering rollers 6A1 and 6B1 are provided with recovering roller cleaning blades 6A2 and 6B2 such that the edges of the blades are in contact with the recovering rollers.

The first and second brush rollers 6A and 6B are connected to power sources 60 and 60′, respectively, such that bias voltages applied to them are different from each other. The recovering rollers 6A1 and 6B1 are connected to power sources 61 and 61′, respectively, such that bias voltages applied to them are different from each other. The recovering roller cleaning blades 6A2 and 6B2 are connected to power sources 62 and 62′, respectively, such that bias voltages applied to them are different from each other. In this manner, in a direction in which the photoconductor drum 1 is moved, the upstream members are respectively given bias voltages opposite to those applied to the downstream members.

In the image forming apparatus having the above-described configuration, the developing device 4 uses a toner whose shape factor 1 (SF-1) has been adjusted to 100 to 150.

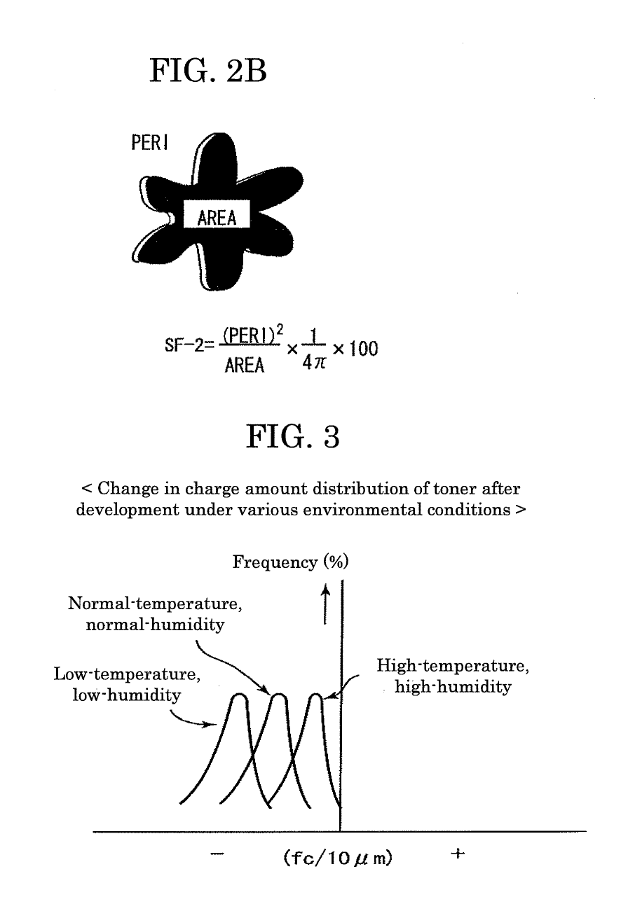

FIGS. 2A and 2B schematically illustrate shapes of toner particles, in order to describe shape factors 1 and 2 (SFs-1 and 2).

The shape factor 1 (SF-1) is a value indicating sphericity of a toner particle, which is given by the following equation (1). Specifically, the shadow of the toner particle is cast on a two-dimensional plane to form a projection image. Subsequently, the maximum length MXLNG of the image is multiplied by itself. The thus-obtained value is divided by an image area AREA, and then multiplied by 100π/4.

SF-1={(MXLNG)²/AREA}×(100π/4) Equation (1)

A toner particle having an SF-1 of 100 is truly spherical. The greater the value SF-1, the more amorphous the toner particle.

The shape factor 2 (SF-2) is a value indicating the degree of surface irregularities of a toner particle, which is given by the following equation (2). Specifically, the shadow of the toner particle is cast on a two-dimensional plane to form a projection image. Subsequently, the periphery PERI of the image is multiplied by itself. The thus-obtained value is divided by an image area AREA, and then multiplied by 100/4π.

SF-2={(PERI)²/AREA}×(100/4π) Equation (2)

A toner particle having an SF-2 of 100 has no surface irregularities. The greater the value SF-2, the more considerable surface irregularities of the toner particle.

Actually, each shape factor was measured as follows. Specifically, a toner particle was photographed with a scanning electron microscope (S-800, product of Hitachi Ltd.), and the thus-obtained image was analyzed using an image analyzer (LUSEX3, product of Nireco Corporation).

When toner particles are each almost spherical, the toner particles each come into point contact with a photoconductor, and one toner particle comes into point contact with other toner particles. As a result, the interacting force between the toner particles becomes weak, increasing the flowability thereof. Also, the interacting force between the toner particles and the photoconductor becomes weak, increasing the transfer rate thereof. Meanwhile, when one of shape factors 1 and 2 (SFs-1 and 2) exceeds 180, the transfer rate is lowered. Also, when toner particles whose shape factor 1 or 2 exceeds 180 adhere to a transfer unit, such toner particles are difficult to clean. Needless to say, both cases are not preferred.

Image forming processing is carried out in the image forming apparatus as follows. Notably, the image forming processing in the present embodiment is based on nega/posi (N/P) inversion development (i.e., toner particles adhere to a portion whose electrical potential is low).

Specifically, a print button is pressed at an unillustrated operation part, a predetermined voltage or current is sequentially applied at a predetermined timing to the charging unit 2, the developing sleeve 4B of the developing device 4, and the transfer device 5. Also in the cleaning device 6, the power sources 60, 60′, 61, 61′, 62 and 62′ individually apply a predetermined voltage or current to corresponding members at a predetermined timing. Upon application of the predetermined voltage or current, the photoconductor drum 1, the charging unit 2, the members housed in the developing device 4, and the transfer device are activated to rotate in directions indicated by arrows in FIG. 1.

The photoconductor drum 1 is uniformly negatively charged (−700 V) by the charging unit, and then exposed to writing laser light emitted from the optical writing device 3, whereby a latent image is formed corresponding to, for example, image information. In this case, the electrical potential of the latent image is adjusted to −120 V at a black solid portion. Also, the linear velocity of the photoconductor drum 1 is adjusted to 205 mm/sec.

When the latent electrostatic image formed on the photoconductor drum 1 is brought into contact with a magnetic brush formed on the developing sleeve 4B of the developing device 4, toner particles of the magnetic brush are electrostatically transferred onto the latent electrostatic image with the aid of electrical potential formed between the latent electrostatic image and the developing bias (−450 V), whereby a visible toner image is formed.

The thus-formed toner image is transferred onto a recording paper, which has been fed through resist rollers 9, by the action of the transfer bias (+18 μA) of the transfer device 5. The recording paper onto which the toner image has been transferred is separated by a separating claw 11 from the photoconductor drum 1 toward a conveying path 12, and then conveyed to an unillustrated fixing device with which the toner image is fixed.

The photoconductor drum 1 having undergone transfer is cleaned with the cleaning device 6 in order for remaining toner particles (e.g., those after transfer) to be removed, and then is quenched with the quenching lamp 7. Thereafter, the resultant photoconductor drum is uniformly charged again with the charging unit 2, and is ready for the next image forming processing.

In the cleaning device 6, the first brush roller 6A is located upstream of the second brush roller 6B in a direction in which the photoconductor drum 1 is moved, and the first and second brush rollers are given bias voltages whose polarities are opposite to each other. In other words, when a positive voltage is applied to the first brush roller, a negative voltage is applied to the second brush roller, and when a negative voltage is applied to the first brush roller, a positive voltage is applied to the second brush roller. With this configuration, even if remaining toner particles on the photoconductor drum 1 contain both positive and negative toner particles, these first and second brush rollers can remove them.

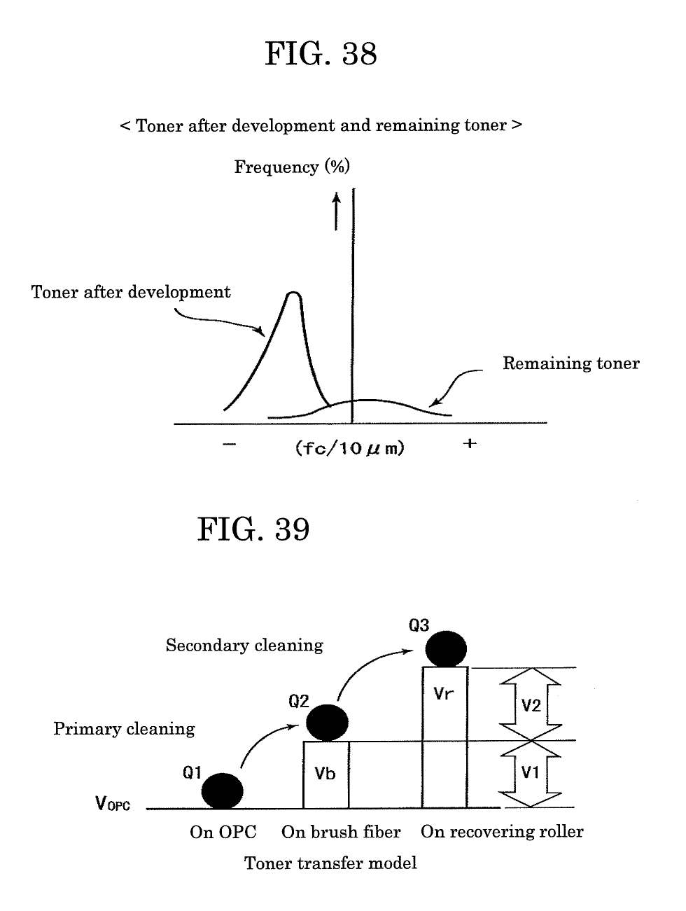

Specifically, the first brush roller 6A is given a positive DC voltage (e.g., +250 V), so that it electrostatically adsorbs “negative” toner particles of a mixture of “positive” and “negative” toner particles remaining on the photoconductor drum 1, and injects charges into non-charged remaining toner particles so as to have a “positive” polarity. This achieves a state where post-transfer remaining toner particles in FIG. 38 all have a “positive polarity.”

The second brush roller 6B is given a negative DC voltage (e.g., −450 V) whose polarity is opposite to that applied to the first brush roller 6A, so that it electrostatically adsorbs positive remaining toner particles obtained as a result of application of a bias voltage by the first brush roller 6A.

The recovering rollers 6A1 and 6B1 are respectively given higher absolute bias voltages than those applied to the brush rollers 6A and 6B, and the remaining toner particles electrostatically adsorbed by the first and second brush rollers 6A and 6B are transferred to the recovering rollers by the action of electrical potential gradients. The remaining toner particles transferred on the recovering rollers 6A1 and 6B1 are scraped off with the recovering roller cleaning blade 6A2 and 6B2, and then they are discharged outside the apparatus or returned to the developing device 4 with a toner discharging screw 6D.

As described above, in the present embodiment, the first brush roller 6A recovers remaining toner particles having a polarity opposite to that applied to the first brush roller, and charges the other remaining toner particles containing even non-charged toner particles on the photoconductor drum 1 so as to have a single polarity, so that the other remaining toner particles charged so as to have a single polarity can be recovered with the second brush roller 6B given a bias voltage having a polarity opposite to it. With this configuration, cleaning performance does not depend on the polarity of the remaining toner particles on the photoconductor drum 1 and thus, the remaining toner particles can be effectively recovered to avoid cleaning failures.

The recovering rollers 6A1 and 6B1 are a member which electrostatically adsorbs the remaining toner particles on the brush rollers 6A and 6B by the action of electrical potential gradient. Thus, unlike the photoconductor drum 1, the recovering rollers do not necessarily have photoconductivity and may be made of optionally selected material. When the recovering rollers 6A1 and 6B1 are coated on their surfaces with a low-friction-coefficient material, or are formed by winding a low-friction-coefficient insulating tube around a metal roller, the recovering roller cleaning blades 6A2 and 6B2 can readily scrape off even spherical toner particles on the recovering rollers.

Notably, a quenching lamp and a pre-cleaning corotron may be provided between the transfer device and the cleaning device.

The pre-cleaning corotron has a discharge wire stretched in an axial direction and a casing covering the discharge wire. The casing has a “U-shaped” cross section whose opening faces an image bearing surface of the photoconductor drum 1. The pre-cleaning corotron “negatively” charges, during operation of the cleaning device, post-transfer remaining toner particles on the image bearing member after completion of image transfer, and shifts their whole charge polarity distribution to fall within the “negative” region. The quenching lamp irradiates the image bearing surface with a quenching light to neutralize surface charges of the image bearing member, allowing easy removal of the post-transfer remaining toner particles from the image bearing member. Thus, use of it can effectively avoid cleaning failures.

Next will be discussed characteristics of members used in the cleaning device of the present embodiment having the above-described configuration.

Specifically, there will be discussed the effects of the configuration of a brush roller, a recovering roller and a recovering roller cleaning blade to charge injection into remaining toner particles.

First will be described effects of changes in environment factors to a charge amount distribution of toner.

The charge amount distribution of toner was determined using an E-SPART analyzer (product of Hosokawa Micron Co.). Specifically, toner particles on the photoconductor drum 1 were blown by pressurized air so that they fall toward a measuring part, where each toner particle was measured for particle diameter and charge amount. The thus-measured values are plotted on a graph whose x axis corresponds to “charge amount/toner particle diameter,” and y axis corresponds to “frequency (%)=number of samples contained in a band of histogram which corresponds to a predetermined “charge amount/toner particle diameter”/total sample number×100.”

FIGS. 3 to 5 show charge amount distributions obtained by changing, as the environmental factors, a temperature and a humidity.

FIG. 3 shows the charge amount of toner after development under high-temperature, high-humidity conditions (30° C. and 90%), under normal-temperature, normal-humidity conditions (20° C. and 50%), or under low-temperature, low-humidity conditions (10° C. and 15%). Toner particles in the developing device 4 are frictionally charged with stirring and thus, charging efficiency decreases with increase in humidity, resulting in decrease in charge amount. As is clear from FIG. 3, the peak of the charge amount distribution obtained under high-temperature, high-humidity conditions is located nearer “0” than does that of the charge amount distribution obtained under normal-temperature, normal-humidity conditions. And, the peak of the charge amount distribution obtained under low-temperature, low-humidity conditions is located farther “0” than does that of the charge amount distribution obtained under normal-temperature, normal-humidity conditions.

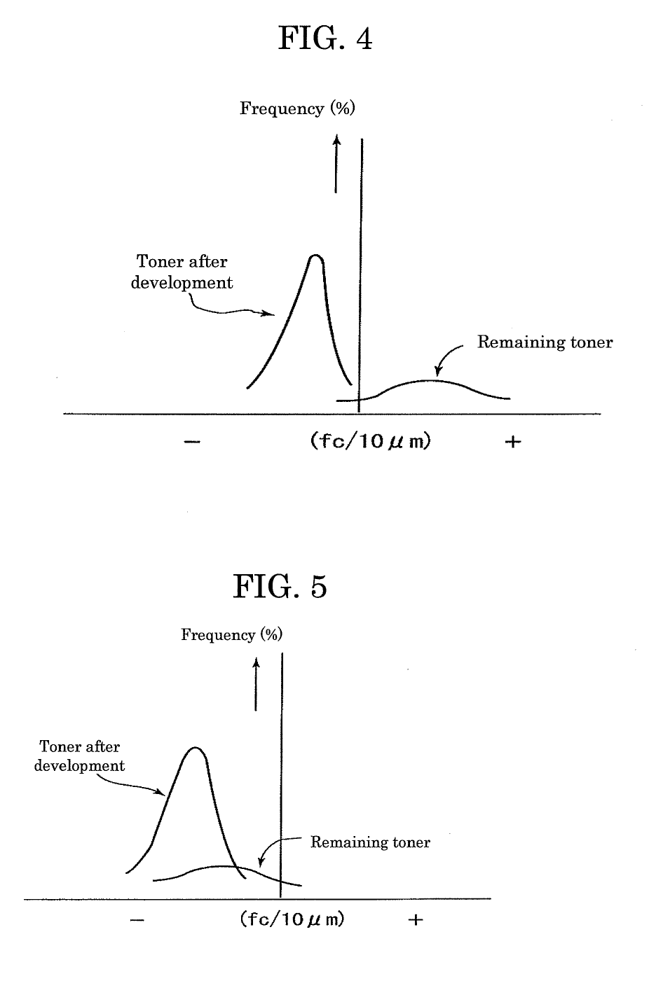

FIG. 4 shows charge amount distributions of toner after development and of remaining toner after transfer, wherein the charge amount distributions are obtained under high-temperature, high-humidity conditions. FIG. 5 shows charge amount distributions of toner after development and of remaining toner after transfer, wherein the charge amount distributions are obtained under low-temperature, low-humidity conditions. The charge amount distribution as shown in FIG. 4 obtained under high-temperature, high-humidity conditions contains more “positive” post-transfer remaining toner particles as compared with the case where the environmental conditions are normal-temperature, normal-humidity conditions (FIG. 3). Meanwhile, the charge amount distribution as shown in FIG. 5 obtained under low-temperature, low-humidity conditions contains more “negative” post-transfer remaining toner particles as compared with the case where the environmental conditions are normal-temperature, normal-humidity conditions (FIG. 3).

Also, the charge amount distribution depends not only on the environmental factors but also on transfer conditions such as the thickness of a recording paper used.

In the present embodiment, an attempt is made to prevent a brush roller from adversely affecting through charge injection the above-described charge amount distribution of the remaining toner. This attempt will be specifically described below.

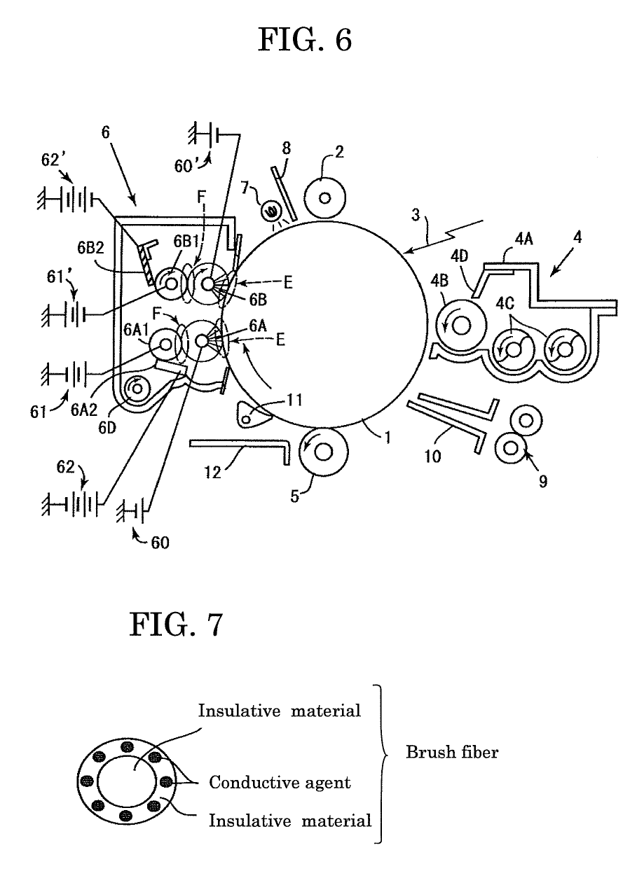

The brush rollers 6A and 6B each have a conductive metal core and brush fibers provided in an outer surface of the conductive metal core. For example, as shown in FIG. 6, the first and second brush rollers 6A and 6B are formed by providing the conductive metal core outer surface with upright brush fibers through electrostatic flocking. Alternatively, they are formed by providing the conductive metal core outer surface with oblique brush fibers (this case is not illustrated).

As shown in FIG. 6, when remaining toner particles come into contact with the first and second brush rollers 6A and 6B in areas where the photoconductor drum 1 is brought into contact with the brush rollers (in FIG. 6, the areas are denoted by reference character E), the polarity of some toner particles having low charge amount is easily inverted through charge injection by the brush rollers. As a result, such toner particles adhere again to the photoconductor drum 1, potentially leading to insufficient cleaning; i.e., cleaning failures. For example, in FIG. 6, the first brush roller 6A given a “positive” bias voltage electrically adsorbs negative remaining toner particles, and injects charges into some remaining toner particles in area E between the first brush roller and the photoconductor drum, to thereby invert their polarity; i.e, “positively” charge them. The resultant positive toner particles go toward the photoconductor drum 1 as a result of repulsion, and adhere again to the photoconductor drum 1.

Also in area E where the second brush roller 6B comes into contact with the photoconductor drum 1, the polarity of remaining toner particles is inverted to be “negative” through application of a bias voltage by the second brush roller 6B, potentially causing the resultant negative toner particles to adhere again to the photoconductor drum 1. Thus, charge injection must be prevented to the greatest extent possible to avoid polarity inversion of remaining toner particles.

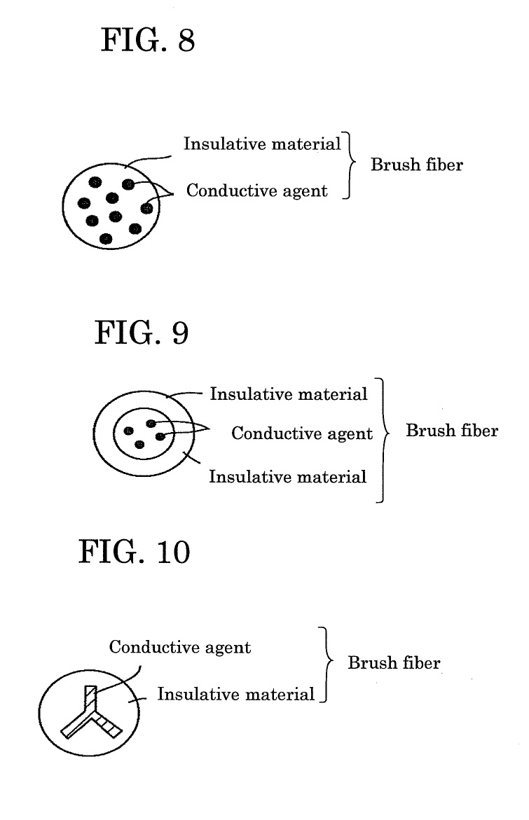

Brush fibers, which are often used for charge injection into remaining toner particles with being formed on the brush rollers, are those containing a conductive agent homogeneously dispersed therein or dispersed only in their surface layers as shown in FIGS. 7 and 8 (e.g., Toray SA-7 (trade name)). When such brush fibers that contain the conductive agent in the above-described states are used, remaining toner particles are highly likely to come into contact with the conductive agent, easily allowing an electrical current to flow into the remaining toner particles. In this configuration, the remaining toner particles tend to have the same polarity as those of voltages applied to the brush rollers and thus, easily adhere again to the photoconductor drum 1.

In addition to the above-described brush fibers each containing the conductive agent dispersed in their surface layers, there are brush fibers each containing the conductive agent located in the vicinity of their center portions.

FIGS. 9 and 10 show the configurations of such brush fibers each containing the conductive agent located in their center portions. Each brush fiber has a sheath structure in which the conductive agent is localized in its center portion and whose surface layer is made of insulating material. Use of the brush fiber having such a structure can prevent remaining toner particles from coming into contact with the conductive agent contained therein.

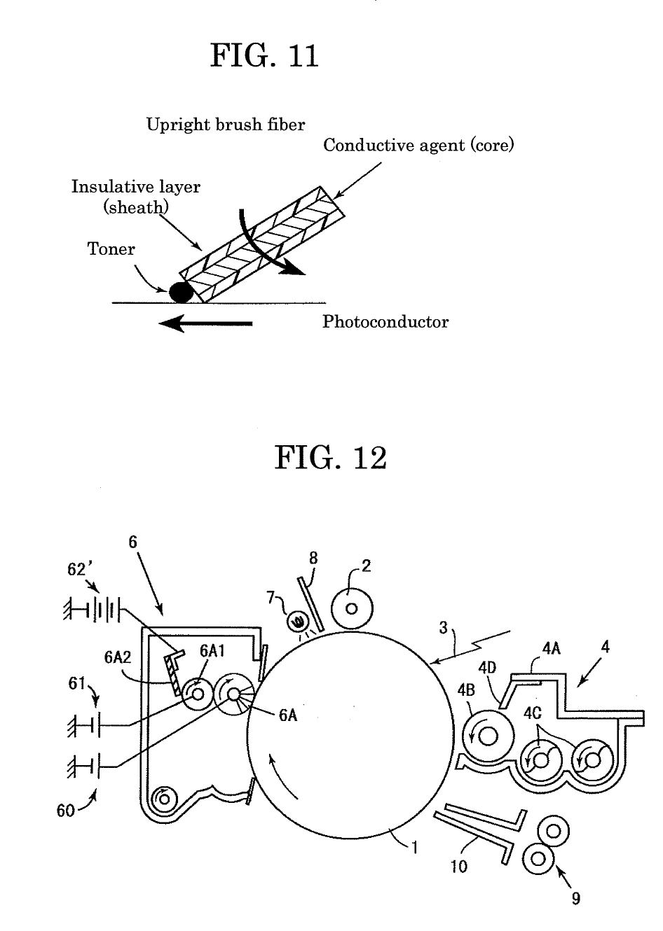

However, when the above-described brush fibers, each containing the conductive agent localized in their center portions, are provided upright in a brush roller, as shown in FIG. 11, the conductive agent exposed on a cross section of each brush fiber comes into contact with remaining toner particles, causing charge injection into the remaining toner particles.

In use of a brush roller whose surface is provided with upright brush fibers as shown in FIG. 11, the conductive agent contained in each brush fiber comes into direct contact with remaining toner particles in area E in FIG. 6 where charge injection occurs. As a result, the polarity of the remaining toner particles, especially, the polarity of some remaining toner particles having low charge amount, is inverted through charge injection. This causes re-adhesion of the remaining toner particles to the photoconductor drum 1, leading to cleaning failures.

Remaining toner particles having high charge amount also undergo charge injection brought by the conductive agent contained in the brush fiber, but their polarity is not inverted since they have high charge amount. Such remaining toner particles that maintain their polarity are moved toward the brush roller 6B which is located downstream of the brush roller 6A in a direction in which the photoconductor drum 1 is moved.

Also in areas F in FIG. 6, charge injection and other phenomena occur similar to in areas E. Specifically, in a configuration in which the recovering rollers 6A1 and 6B1, provided so as to be in contact with the brush rollers 6A and 6B, are given bias voltages having opposite polarities to those of bias voltages applied to the brush rollers 6A and 6B, some remaining toner particles having low charge amount are not transferred from the brush rollers to the recovering rollers and have the same polarity as those of the bias voltages applied to the recovering rollers. As a result, such remaining toner particles adhere again to the brush rollers through repulsion by the recovering rollers. For the above-described reasons, the remaining toner particles adhering to the brush rollers adhere again to the photoconductor drum 1, resulting in cleaning failures.

Through experiments, the present inventor confirmed that the brush rollers shown in FIG. 6 whose surfaces are provided with upright brush fibers caused charge injection into remaining toner particles in areas E and F.

The configuration of a cleaning device shown in FIG. 12 is the same as that of the cleaning device shown in FIG. 6, except that the members other than the first brush roller 6A, the recovering roller 6A1, and the recovering roller cleaning blade 6A2 are removed. Also, the transfer device 5 is not provided in an image forming apparatus shown in FIG. 12. As described above, this image forming apparatus is used for investigating cleaning performance of the first cleaning brush 6A with respect to toner particles remaining after development almost 100% of which has been “negatively” charged. Notably, for the sake of convenience, the first brush roller 6A, the recovering roller 6A1, and the recovering roller cleaning blade 6A2 shown in FIG. 12 are illustrated similar to the second brush roller 6B, the recovering roller 6B1, and the recovering roller cleaning blade 6B2 shown in FIG. 1, since the members 6A, 6A1 and 6A2 in FIG. 12 have the same functions as the members 6B, 6B1 and 6B2.

In the configuration shown in FIG. 12, rotation of the photoconductor drum 1 was stopped at a time when the top end of a toner image moved from a contact portion between the first brush roller 6A and the photoconductor drum 1 by a distance equivalent to twice the circumferential length of the first brush roller 6A (i.e., a distance corresponding to 2×rotation of the first brush roller 6A). And, the amount of toner particles deposited (i.e., a post-cleaning toner ID (q/d) distribution) was measured on a surface of the photoconductor drum 1 which surface ranges from a position distant from the contact position by the circumferential length to a position distant from the contact position by twice the circumferential length.

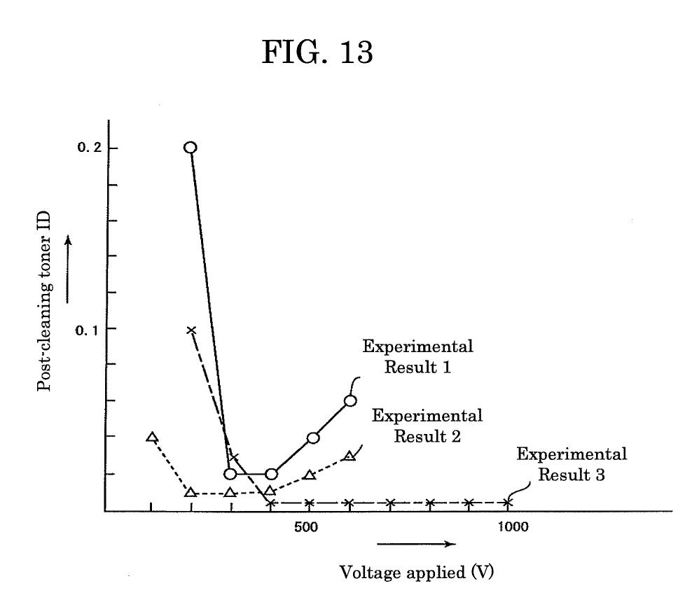

The data obtained from the experiment performed in this configuration correspond to those indicated by “Experimental Result 1” in FIG. 13.

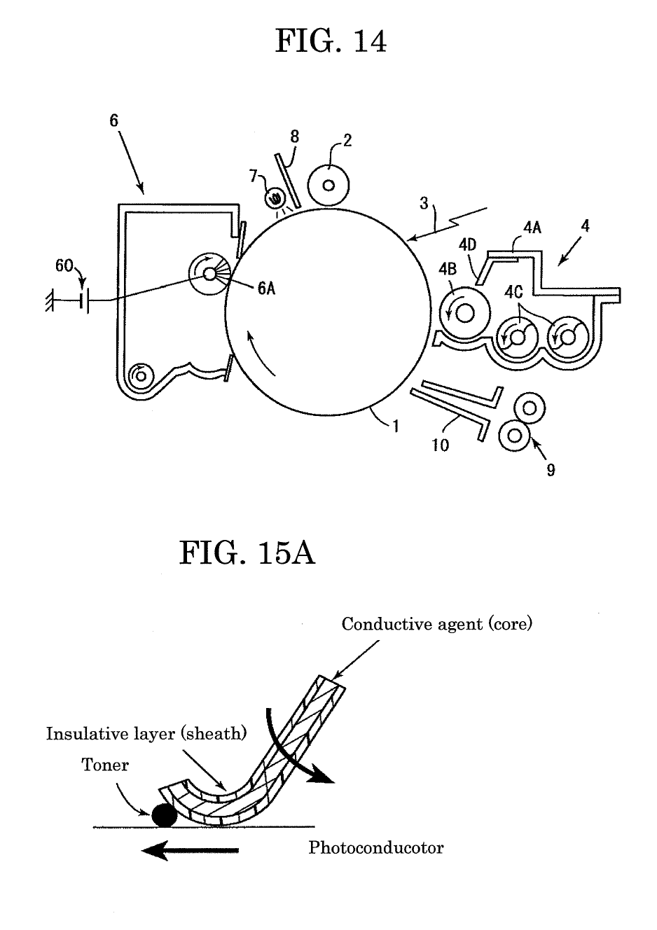

Also, an experiment was performed on charge injection occurring in area F shown in FIG. 6. As shown in FIG. 14, a cleaning device employed in this experiment had the same configuration as the cleaning device shown in FIG. 12, except that the members other than the brush roller 6A were removed. The conditions under which this experiment was performed were the same as those under which the experiment was performed using the image forming apparatus shown in FIG. 12. The data obtained from this experiment correspond to those indicated by “Experimental Result 2” in FIG. 13.

In a graph of FIG. 13, the horizontal axis corresponds to a voltage applied to the brush roller or the recovering roller, and the vertical axis corresponds to a density of remaining toner; i.e., a post-cleaning toner ID.

The post-cleaning toner ID corresponding to the vertical axis is measured as follows. Specifically, a piece of Scotch tape (trade name) is attached to a portion of the photoconductor drum 1, the portion being a portion located downstream of the cleaning brush 6A in a direction in which the photoconductor drum is rotated. Then, the piece to which toner has adhered is attached to a paper sheet, and is measured for reflection density with a spectrophotometer (X-Rite 938, product of X-Rite Co.) to give a measurement value.

Separately, a piece of Scotch tape (trade name) which has not been attached to the photoconductor drum 1 is attached to a paper sheet, and is measured with the spectrophotometer to give a control value. Then, the post-cleaning toner ID is calculated by subtracting the control value from the measurement value.

The post-cleaning toner ID is correlated with the number of toner particles. In other words, the number of toner particles is increased in accordance with increase of the post-cleaning toner ID. Cleaning performance, therefore, can be judged considering the post-cleaning toner ID indicating the amount of remaining toner.

From the experiment performed using the image forming apparatus shown in FIG. 12, in accordance with increasing of a voltage applied, the post-cleaning toner ID was found to become small until the voltage reached +300 V, but to become large after the voltage exceeded +400 V. Meanwhile, from the experiment performed using the image forming apparatus shown in FIG. 14, in accordance with increasing of a voltage applied, the post-cleaning toner ID was found to become small until the voltage reached +200 V, but to become large after the voltage exceeded +400 V.

As described above, in the image forming apparatus having such a configuration that includes a photoconductor and first and second brush rollers 6A and 6B each having a sheath structure whose surface is provided with upright brush fibers, the first brush roller being provided upstream of the second brush roller in a direction in which the photoconductor is rotated, it is obvious that charge injection into remaining toner particles occurs in contact areas (denoted by reference character E) between the brush rollers and the photoconductor drum and in contact areas between the brush rollers and the recovering rollers, and that the remaining toner particles are inverted in polarity to be transferred to the photoconductor drum by the brush rollers and to be transferred to the brush rollers by the recovering rollers.

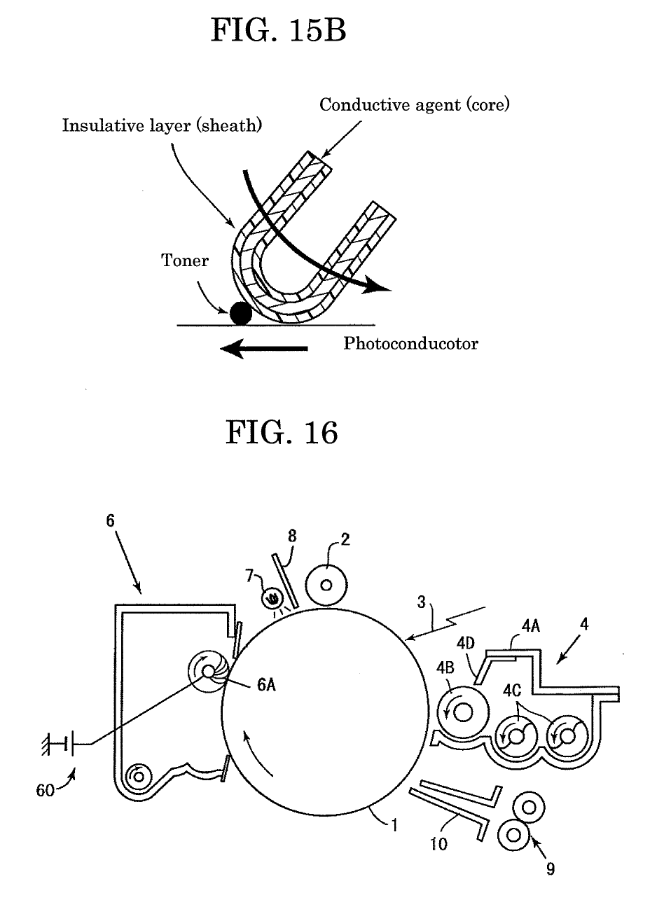

In view of this, rather than a brush roller whose surface is provided with upright brush fibers, use of a brush roller having a brush fibers obliquely provided (see FIG. 15A) or looped (see FIG. 15B) so that their cross sections do not come into contact with remaining toner particles can prevent the conductive agent contained therein from coming into direct contact with the remaining toner particles. In this case, the brush fibers are made, for example, of insulating materials such as nylon, polyesters (among others, polyethylene terephthalate (PET)), acrylic acid resins and rayon.

Using an image forming apparatus shown in FIG. 16 whose brush roller 6A has oblique brush fibers each having a sheath structure shown in FIG. 9 or 10, an experiment was performed on the post-cleaning toner ID under the same conditions as those under which the experiment was performed using the image forming apparatus shown in FIG. 14. The data obtained from this experiment correspond to those indicated by “Experimental Result 3” in FIG. 13.

As is clear from FIG. 13, from the experiment performed using the image forming apparatus shown in FIG. 16, the post-cleaning toner ID was found to become small in accordance with increasing of a voltage applied until the voltage reached +400 V, but to be maintained low after the voltage exceeded +400 V.

The thus-obtained experimental data indicate that the toner particles corresponding to an increase of the post-cleaning toner ID in accordance with increasing of a voltage applied to brush rollers all have the same polarity as that of the voltage; i.e., are those having undergone charge injection. In these experiments, almost all the toner particles corresponding to a post-cleaning toner ID at an applied voltage of 500 V or higher in FIG. 13 were found to have a “positive polarity.”

In contrast, a post-cleaning toner ID at low applied voltages corresponds to toner particles which have not been removed since the electric field applied to them is weak. Almost all the toner particles corresponding to a post-cleaning toner ID at an applied voltage of 200 V or lower in FIG. 13 (at an applied voltage of 100 V or lower in the experiment performed using the image forming apparatus shown in FIG. 12) were found to have a “negative polarity.”

Experimental Results 1 and 2 shown in FIG. 13 clearly indicate that charge injection occurs in spaces between the photoconductor drum 1 and the brush roller and between the brush roller and the recovering roller. In contrast, Experimental Result 3, which is obtained using the image forming apparatus shown in FIG. 16 whose brush roller has a surface provided with obliquely arranged brush fibers each having a sheath structure, clearly indicates that almost no charge injection occurs. Although Experimental Result 3 was obtained using the image forming apparatus shown in FIG. 16 containing no recovering roller, it is obvious that that the occurrence of charge injection is reduced between the brush roller and the recovering roller.

Charge injection into toner particles can be prevented not only by modifying the state where brush fibers are provided in a brush roller but also by forming a recovering roller, which is in contact with a brush roller, so that it does not easily inject charges into toner particles. Next will be described prevention of charge injection by appropriately forming a recovering roller.

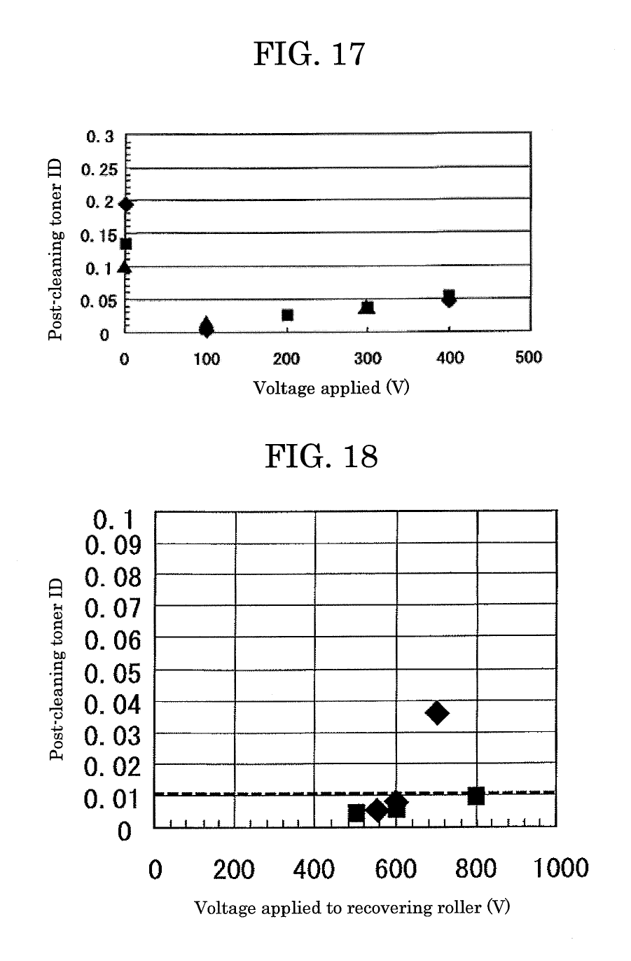

FIGS. 17 and 18 show data obtained through an experiment using the image forming apparatus shown in FIG. 12 whose recovering roller 6A1 has a conductive, resistive or insulative surface. The experimental conditions and manners were the same as those under which the data shown in FIG. 13 were obtained, except that almost 100% of the remaining toner particles conveyed to the brush roller (i.e., toner particles after development) was adjusted to have a “negative” polarity.

FIG. 17 shows data obtained when the recovering roller has a conductive or resistive surface layer. FIG. 18 shows data obtained when the recovering roller has an insulative surface layer. The conductive surface layer is made of SUS serving as a surface layer material. The resistive surface layer is made of PDVF serving as a surface layer material. The insulative surface layer is made of acrylic coating serving as a surface layer material. Note that a recovering roller having a highly resistive surface layer does not exhibit the effect of reducing charge injection.

As is clear from data shown in FIG. 17 which are obtained when the recovering roller has a conductive or resistive surface, a post-cleaning toner ID decreases in accordance with increasing of a voltage applied until the voltage reaches +100 V, but increases after the voltage exceeds +100 V.

Meanwhile, as is clear from data shown in FIG. 18 which are obtained when the recovering roller has an insulative surface, a post-cleaning toner ID is maintained low regardless of increasing of a voltage applied. Notably, a post-cleaning toner ID lower than 0.01 is preferred. This indicates that the brush roller or the recovering roller having a conductive or resistive surface layer injects charges into toner particles similar to the case where some data shown in FIG. 13 are obtained.

Here, even when a recovering roller has a conductive or resistive surface layer rather than an insulative surface layer, a post-cleaning toner ID may be decreased by adjusting a voltage applied. Considering that a charge amount of toner changes depending on changes of environmental factors, however, it is impossible to think that a post-cleaning toner ID can be decreased by adjusting a voltage applied to the recovering roller having a conductive or resistive surface layer.

As described above in relation to FIGS. 3 to 5, a charge amount distribution of toner varies with changes of environmental factors. Here, a voltage applied to the recovering roller cannot be rapidly controlled in response to changes of environmental factors and thus, a post-cleaning toner ID cannot be decreased in the above-described manner.

When a recovering roller having an insulative surface layer is used, charges must be supplied to a surface of the recovering roller to prevent a drop in cleaning performance. Charges are required to be supplied through discharge to the recovering roller, since charge supply cannot efficiently be performed only by bringing a member given a voltage into contact with a surface of the recovering roller. For example, corona discharge is employed to supply charges to the recovering roller. In addition, discharge is generated by disposing a member given a voltage proximately to a surface of the recovering roller.

Examples of the insulative layer of the recovering roller 6A1 or 6B1 include PVDF tubes, PFA tubes, PI tubes, acrylic coatings, silicone coatings (e.g., silicone particles-containing polycarbonate (PC) coatings), ceramics, and fluorine coatings. The thickness of the coat (cover) layer (insulative layer) is appropriately determined. For example, it is set to about 3 μm to about 20 μm when an acrylic coating is used.

In order to impart increased ablation resistance to the recovering roller cleaning blades 6A2 or 6B2 which is in contact with the recovering roller 6A1 or 6B1, the recovering roller cleaning blade may be treated to have a coat (cover) layer which is the same as that of the recovering roller. Provision of the coat layer decreases the friction coefficient of an edge of the blade, and achieves a state where the blade edge stably comes into contact with the recovering roller, resulting in attainment of stable cleaning performance.

Furthermore, the diameters of the brush and recovering rollers are adjusted depending on the outer diameter of a photoconductor drum and on the feeding rate of a recording paper. For example, the image forming apparatus shown in FIG. 1, the diameters of the brush rollers 6A and 6B are set to a value falling within a range of 6 mm to 24 mm, the brush fiber height calculated from the length of the brush fiber is set to a value falling within a range of 2.5 mm to 8 mm, and the diameters of the recovering rollers 6A1 and 6B1 are set to a value falling within a range of 6 mm to 24 mm. In this case, the resistance values of the brush rollers 6A and 6B are appropriately set to a value falling within a range of 10⁵ Ω·cm to 10¹⁰ Ω·cm. The linear velocity of the photoconductor drum 1 is set to a value falling within a range of 100 mm/sec to 500 mm/sec.

Also, the present inventor confirmed through experiments that good cleaning performance could not be obtained when the first and second brush rollers have a surface provided with brush fibers each having a structure shown in FIG. 9 or 10 and being arranged in a manner shown in FIG. 15A or 15B.

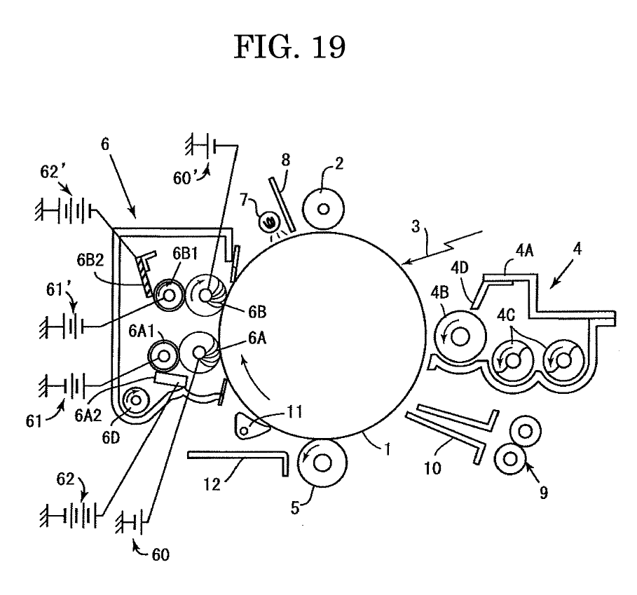

An image forming apparatus shown in FIG. 19 includes first and second brush rollers which have a surface provided with brush fibers each having a sheath structure shown in FIG. 9 or 10 and being obliquely arranged as shown in FIG. 15A. Further information concerning the brush rollers and other members is given below.

### Brush Rollers 6A and 6B:

Material: conductive polyester

Backing width: 5 mm

Brush fiber height: 3 mm

Conductive agent: core-in-sheath structure (FIG. 10)

Arrangement of brush fibers: obliquely provided (FIG. 15A)

Resistance of brush original yarn: 10⁸ Ω·cm

Brush fiber density: 100,000/inch² (1 inch=0.0254 m)

Intrusion amount with respect to photoconductor drum: 1 mm

### Recovering Rollers 6A1 and 6B1:

Material: metal core: SUS

Intermediate layer: PVDF tube (100 μm)

Surface layer: acrylic coat (10 μm)

Diameter each of the recovering rollers: 12 mm

Intrusion amount with respect to brush fibers: 1 mm

### Recovering Roller Cleaning Blades 6A2 and 6B2:

Material: dispersion of conductive agent in polyurethane rubber

Angle at which the blades come into contact with the rollers: 20°

Intrusion amount with respect to recovering rollers: 1 mm

### Voltages Applied (by Power Sources 60, 60′, 61, 61′, 62 and 62′ in FIG. 1):

Power source 60: +300 V

Power source 61: +700 V

Power source 62: +1,800 V

Power source 60′: −450 V

Power source 61′: −800 V

Power source 62′: −2,100 V

When an experiment was performed using the image forming apparatus shown in FIG. 19 under the above-described conditions, remaining toner particles, which had not been removed, were observed on a portion of the photoconductor which portion is located downstream of the second brush roller 6B. The remaining toner particles were measured for charge amount distribution with an E-SPART analyzer (product of Hosokawa Micron Co.). As a result, most of them were found to have no charges (zero distribution).

As shown in a charge amount distribution of FIG. 38, remaining toner particles contain non-charged toner particles in addition to “positively charged” and “negatively charged” toner particles. The upstream brush given a positive voltage can remove “negatively charged” toner particles, while the downstream brush given a negative voltage can remove “positively charged” toner particles. However, non-charged toner particles cannot be removed in principle. Such non-charged toner particles may be scraped off by increasing a pressure at which the brush fibers come into contact with the image bearing member; i.e., a member to be cleaned. But, as described above, increasing of the contact pressure between the brush fibers and the image bearing member gives more damage to the image bearing member.

Also, when a large amount of toner particles remain on the image bearing member after transfer, a pre-cleaning charger cannot charge them so as to have a charge amount distribution covering a certain range only in the “negative” region. As a result, some non-charged toner particles are moved to a contact area between the subsequent brush roller and the image bearing member.

In view of the above-obtained experimental results and the above-described charge injection into toner particles, in the present embodiment, the first brush roller 6A is a brush roller having brush fibers whose conductive agent is homogeneously dispersed therein or dispersed only in their surfaces, and the second brush roller 6B is a brush roller having oblique brush fibers shown in FIG. 15A or looped brush fibers shown in FIG. 15B whose conductive agent is localized in their center portions without being dispersed in surfaces thereof as shown in FIG. 9 or 10.

In the above-described configuration, the first brush roller 6A electrostatically adsorbs remaining toner particles while injecting charges into non-charged toner particles, and the second brush roller 6B electrostatically adsorbs remaining toner particles without injecting charges into toner particles. With this configuration, all the remaining toner particles can be cleaned by the second brush roller 6B; i.e., there can be cleaned toner particles remaining on the photoconductor drum 1 which contain positively charged, negatively charged, and non-charged toner particles.

Notably, a positive voltage and a negative voltage may be applied to an upstream brush roller and a downstream brush roller in a direction in which the photoconductor drum 1 is moved, respectively, and a positive voltage and a negative voltage may be applied to a downstream recovering roller and an upstream recovering roller, respectively. Alternatively, a positive voltage and a negative voltage may be applied to a downstream brush roller and an upstream brush roller in a direction in which the photoconductor drum 1 is moved, respectively, and a positive voltage and a negative voltage may be applied to an upstream recovering roller and a downstream recovering roller, respectively.

### EXAMPLES

Next will be described an Example based on the present embodiment.

Notably, unless otherwise specified, the unit “part(s)” means the unit “part(s) by mass in the below-given Examples.

### Example 1

In this Example, there is used an image forming apparatus shown in FIG. 1 whose second brush roller 6B has obliquely provided brush fibers (shown in FIG. 15A) with a sheath structure shown in FIG. 9 or 10.

Next will be given specific information concerning some constituent members of the cleaning device. The specific information will be described in a manner similar to that employed above in relation to the experiment using the image forming apparatus shown in FIG. 19.

### First Brush Roller 6A:

Material: conductive polyester

Backing width: 5 mm

Brush fiber height: 3 mm

Conductive agent: homogeneously dispersed in a surface (FIG. 8)

Arrangement of brush fibers: upright provided

Diameter of the brush roller: 14 mm

Resistance of brush original yarn: 10⁸ Ω·cm

Brush fiber density: 100,000/inch² (1 inch=0.0254 m)

Intrusion amount with respect to photoconductor drum: 1 mm

### Recovering Roller 6A1:

Material: metal core: SUS

Intermediate layer: PVDF tube (100 μm)

Surface layer: acrylic coat (10 μm)

Diameter of the brush roller: 12 mm

Intrusion amount with respect to brush fibers: 1 mm

### Recovering Roller Cleaning Blade 6A2:

Material: dispersion of conductive agent in polyurethane rubber

Surface: acrylic coat (10 μm)

Angle at which the blade comes into contact with the roller: 20°

Intrusion amount with respect to recovering roller: 1 mm

### Second Brush Roller 6B:

Material: conductive polyester

Backing width: 5 mm

Conductive agent: core-in-sheath structure (FIG. 10)

Arrangement of brush fibers: obliquely provided (FIG. 15A)

Brush fiber height: 3 mm

Diameter of the brush roller: 14 mm

Resistance of brush original yarn: 10⁸ Ω·cm

Brush fiber density: 100,000/inch² (1 inch=0.0254 m)

Intrusion amount with respect to photoconductor drum: 1 mm

### Recovering Roller 6B1:

Material: metal core: SUS

Intermediate layer: PVDF tube (100 μm)

Surface layer: acrylic coat (10 μm)

Diameter of the recovering roller: 12 mm

Intrusion amount with respect to brush fibers: 1 mm

### Recovering Roller Cleaning Blade 6B2:

Material: dispersion of conductive agent in polyurethane rubber

Surface: acrylic coat (10 μm)

Angle at which the blade comes into contact with the roller: 20°

Intrusion amount with respect to recovering roller: 1 mm Voltages applied:

Power source 60: +250 V

Power source 61: +700 V

Power source 62: +1,650 V

Power source 60′: −450 V

Power source 61′: −800 V

Power source 62′: −1,950 V

Also, an AC voltage may be superposed on a voltage applied from the power source 60 or 60′. In this case, for example, an unillustrated power source for the power source 60 is set to 2.5 kVpp, 600 Hz and +600 V, and an unillustrated power source for the power source 60′ is set to 2.5 kVpp, 600 Hz and −750 V.

The voltage may be appropriately adjusted in consideration of the linear velocity of the recovering roller, and a temperature and humidity in the environmental conditions.

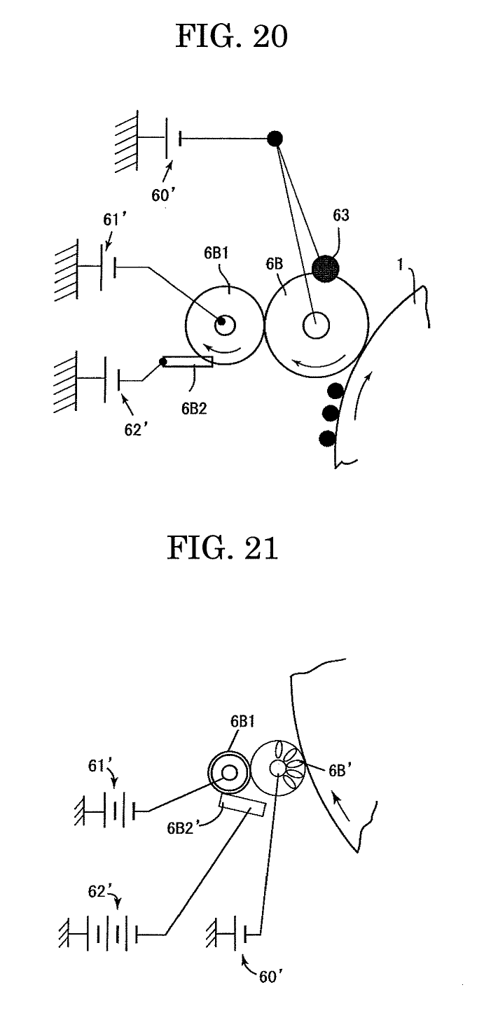

The essential parts of the image forming apparatus shown in FIG. 1 may be modified as shown in FIG. 20. Specifically, a member 63 is disposed so as to be in contact with the tips of the brush fibers of the downstream second brush roller 6B, in order to supply charges to the brush fiber tips. If necessary, the member 63 may be used for supplying charges to the tips of the brush fibers of the upstream first brush roller 6A.

The member 63 is, for example, a 0.1 mm-thick SUS plate or conductive film whose end is rounded. It is made to intrude in the brush fibers by about 0.5 mm so that the member lightly comes into contact with the brush fibers.

When the member 63 is provided for the first and second brush rollers 6A and 6B, the power sources 60 and 60′ may be used for applying a voltage to it. Alternatively, an additional power source may be provided for applying an appropriate voltage to it.

With this configuration, an electric field is stable between the tips of the brush fibers and the photoconductor drum and thus, toner particles remaining on the photoconductor drum can be reliably transferred to the brush roller.

### Example 2

In Example 2, there is used an image forming apparatus whose second brush roller 6B, which is disposed downstream of the first brush roller in a direction in which the photoconductor drum 1 is moved, has looped brush fibers as shown in FIG. 15B.

FIG. 21 is an enlarged view of the looped brush fibers of the second brush roller (for the sake of convenience, each looped brush fiber is denoted by reference character 6B′).

In the image forming apparatus shown in FIG. 1, the second brush roller 6B has obliquely provided brush fibers which come into contact with the photoconductor as shown in FIG. 15A. But, as time passes, the brush fibers change in form from the initial state, potentially resulting in that they come into contact with remaining toner particles as shown in FIG. 11. In view of this, even after change in form over time, the brush fibers are looped, preventing the conductive agent from coming into contact with toner particles.

In the looped brush fibers, the conductive agent contained therein is not exposed at all. Thus, it does not come into direct contact with remaining toner particles, preventing charge injection.

Next will be given specific information of the second brush roller 6B in a manner similar to that employed in Example 1.

### Second Brush Roller 6B:

Material: conductive polyester

Backing width: 5 mm

Conductive agent: core-in-sheath structure (FIG. 10)

Arrangement of brush fibers: looped (FIG. 15B)

Brush fiber height: 3 mm

Diameter of the brush roller: 14 mm

Resistance of brush original yarn: 10⁸ Ω·cm

Brush fiber density: 450±45 (loops)/inch² (1 inch=0.0254 m)

Intrusion amount with respect to photoconductor drum: 1 mm

### Voltages Applied:

Power source 60: +250 V

Power source 61: +650 V

Power source 62: +1,650 V

Power source 60′ (not illustrated): −520 V

Power source 61′ (not illustrated): −900 V

Power source 62′ (not illustrated): −1,950 V

Also, an AC voltage may be superposed on a voltage applied from the power source 60 or 60′. The voltage may be appropriately adjusted in consideration of the linear velocity of the recovering roller, and a temperature and humidity in the environmental conditions.

Also, as shown in FIG. 20, the member 63 may be disposed so as to be in contact with the tips of the brush fibers of the downstream second brush roller 6B, in order to supply charges to the brush fiber tips. Furthermore, the member 63 may be provided for supplying charges to the tips of the brush fibers of the first brush roller 6A.

### Example 3

The configuration of this Example is characterized in that the metal core of the recovering roller is connected to the ground.

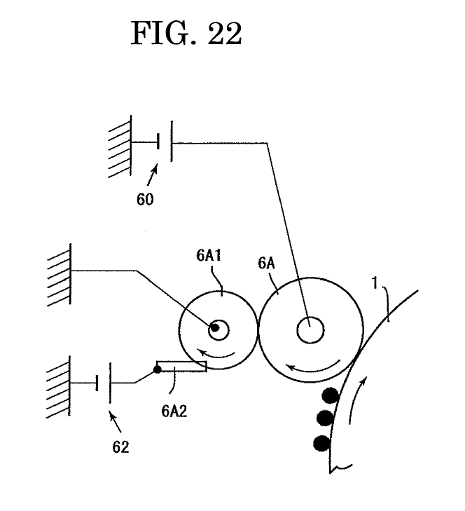

FIG. 22 is an enlarged view of the recovering roller 6A1 which is in contact with the first brush roller 6A. In this figure, the metal core of the recovering roller 6A1 is not given a voltage but connected to the ground.

Here, voltages applied to members are set as follows.

### Voltages Applied:

Power source 60: +250 V

Recovering roller 6A1: 0 V (connected to the ground)

Power source 62: +1,100 V

Power source 60′ (not illustrated): −450 V

Recovering roller 6B1 (not illustrated): 0 V (connected to the ground)

Power source 62′ (not illustrated): −1,200 V

Also, an AC voltage may be superposed on a voltage applied from the power source 60 or 61. In this case, for example, an unillustrated power source for the power source 60 is set to 2.5 kVpp, 600 Hz and +600 V, and an unillustrated power source for the power source 60′ is set to 2.5 kVpp, 600 Hz and −750 V.

Also, as shown in FIG. 20, the member 63 may be disposed so as to be in contact with the tips of the brush fibers of the downstream second brush roller 6B, in order to supply charges to the brush fiber tips.

Furthermore, as shown in FIG. 20, the member 63 may be provided for supplying charges to the tips of the brush fibers of the upstream first brush roller 6A.

### Example 4

The configuration of this Example is characterized in that the recovering roller is a medium resistance member.

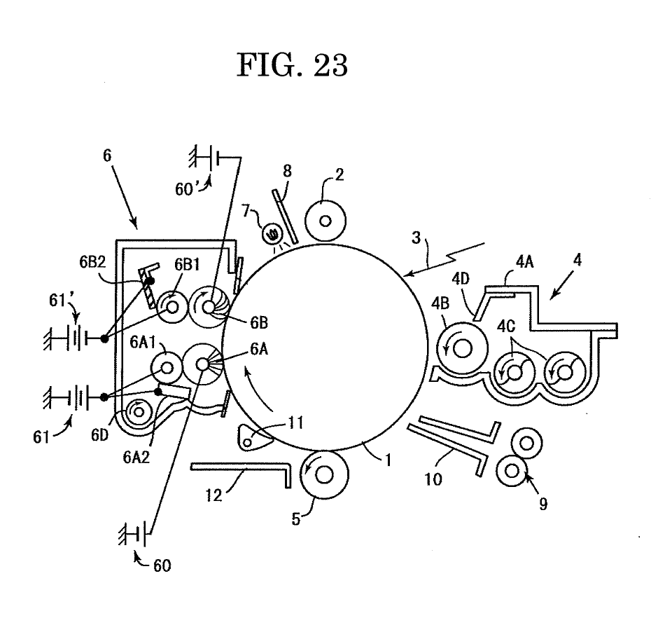

FIG. 23 shows the configuration of this Example. In this figure, the recovering roller 6A1 or 6B1 has a medium resistance surface layer.

The recovering roller cleaning blade 6A2 or 6B2 having a medium resistance surface layer requires reduced voltage applied thereto. Also, even when accumulated on a surface of the recovering roller, counter charges run through the medium resistance surface layer to the metal core. As a result, a surface potential of the recovering roller is stabilized, which reliably enables toner particles to transfer from the brush fibers to the recovering roller. Furthermore, the recovering roller 6A1 and the recovering roller cleaning blade 6A2 are given a voltage from a common power source, and the recovering roller 6B1 and the recovering roller cleaning blade 6B2 are given a voltage from a common power source, leading to reduction of space and cost.

Specific information concerning constituent members is given below.

### First Brush Roller 6A:

Material: conductive polyester

Backing width: 5 mm

Brush fiber height: 3 mm

Conductive agent: homogeneously dispersed in a surface (FIG. 8)

Arrangement of brush fibers: upright provided

Diameter of the brush roller: 14 mm

Resistance of brush original yarn: 10⁸ Ω·cm

Brush fiber density: 100,000/inch² (1 inch=0.0254 m)

Intrusion amount with respect to photoconductor drum: 1 mm

### Recovering Roller 6A1:

Material: metal core: SUS

Resistive layer: carbon-dispersed phenol resin (2 mm)

Diameter of the recovering roller: 12 mm

Intrusion amount with respect to brush fibers: 1 mm

### Recovering Roller Cleaning Blade 6A2:

Material: dispersion of conductive agent in polyurethane rubber

Angle at which the blade comes into contact with the roller: 20°

Intrusion amount with respect to recovering roller: 1 mm

### Second Brush Roller 6B:

Material: conductive polyester

Backing width: 5 mm

Conductive agent: core-in-sheath structure (FIG. 10)

Arrangement of brush fibers: obliquely provided (FIG. 15A)

Brush fiber height: 3 mm

Diameter of the brush roller: 14 mm

Resistance of brush original yarn: 10^{8 Ω·cm}

Brush fiber density: 100,000/inch² (1 inch=0.0254 m)

Intrusion amount with respect to photoconductor drum: 1 mm

### Recovering Roller 6B1:

Material: metal core: SUS

Resistive layer: carbon-dispersed phenol resin (2 mm)

Diameter of the recovering roller: 12 mm

Intrusion amount with respect to brush fibers: 1 mm

### Recovering Roller Cleaning Blade 6B2:

Material: dispersion of conductive agent in polyurethane rubber

Angle at which the blade comes into contact with the roller: 200

Intrusion amount with respect to recovering roller: 1 mm

### Voltages Applied:

Power source 60: +250 V

Power source 61: +700 V

Power source 60′: −400 V

Power source 61′: −850 V

The voltage may be appropriately adjusted in consideration of the linear velocity of the recovering roller, and a temperature and humidity in the environmental conditions.

Also, as shown in FIG. 20, the member 63 may be provided for supplying charges to the tips of the brush fibers of the second brush roller 6B, or of both the first and second brush rollers 6A and 6B.

### Example 5

The configuration of this Example corresponds to a configuration described in claim 3, and is characterized in that the recovering roller 6A1 being in contact with the first brush roller 6A has a medium surface resistance and that the recovering roller 6B1 being in contact with the second brush roller 6B has an insulative surface layer.

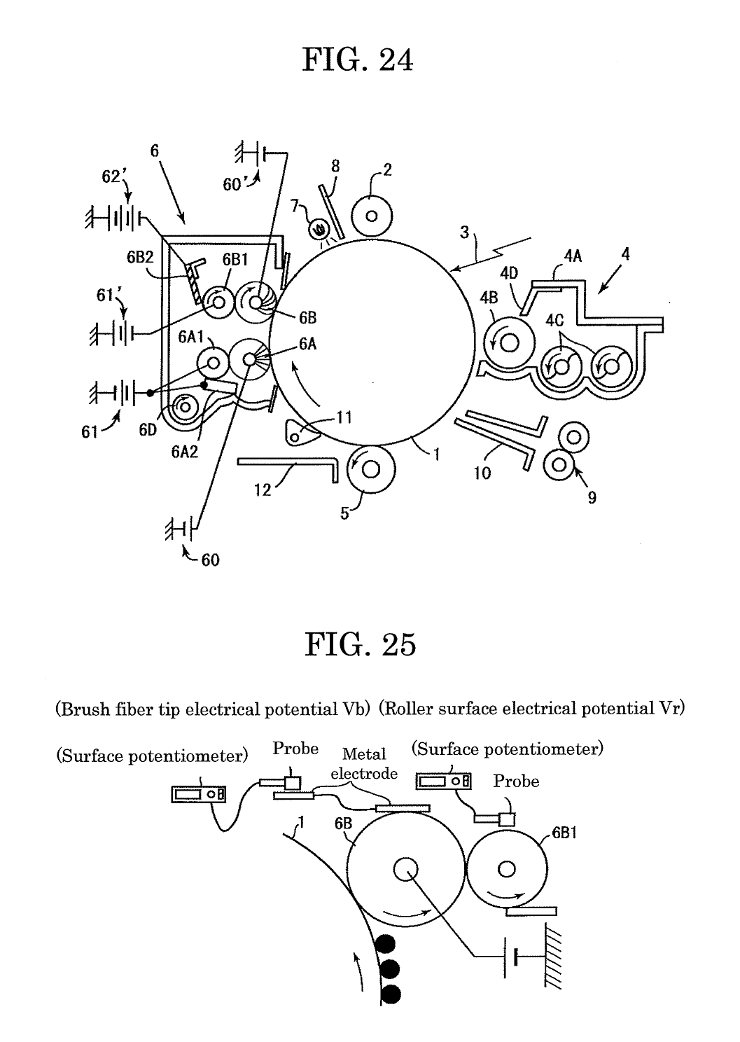

FIG. 24 shows the configuration of this Example. In this configuration, the recovering roller 6A1 being in contact with the first brush roller 6A is a medium resistance member similar to the configuration shown in FIG. 23, and the recovering roller 6B1 being in contact with the second brush roller 6B has an insulative surface layer similar to the configuration shown in FIG. 1.

As described above, charge injection into toner particles also occurs in an area where the brush roller is in contact with the recovering roller (in FIG. 6, the area is denoted by reference character F).

When charge injection into toner particles occurs between the second brush roller 6B and the recovering roller 6B1 which are located downstream of the first brush roller and the recovering roller therefor in a direction in which the photoconductor drum 1 is moved, the toner particles are inverted in polarity and transferred from the brush fibers to the photoconductor, leading to cleaning failures. As discussed above, when the recovering roller 6B1 being in contact with the second brush roller 6B has an insulative surface layer, the toner particles are not inverted in polarity to prevent re-adhesion to the photoconductor.

Specific information concerning constituent members is given below.

### First Brush Roller 6A:

Material: conductive polyester

Backing width: 5 mm

Brush fiber height: 3 mm

Conductive agent: homogeneously dispersed in a surface (FIG. 8)

Arrangement of brush fibers: upright provided

Diameter of the brush roller: 14 mm

Resistance of brush original yarn: 10⁸ Ω·cm

Brush fiber density: 100,000/inch² (1 inch=0.0254 m)

Intrusion amount with respect to photoconductor drum: 1 mm

### Recovering Roller 6A1:

Material: metal core: SUS

Resistive layer: carbon-dispersed phenol resin (2 mm)

Diameter of the recovering roller: 12 mm

Intrusion amount with respect to brush fibers: 1 mm

### Recovering Roller Cleaning Blade 6A2:

Material: dispersion of conductive agent in polyurethane rubber

Angle at which the blade comes into contact with the roller: 20°

Intrusion amount with respect to recovering roller: 1 mm

### Second Brush Roller 6B:

Material: conductive polyester

Backing width: 5 mm

Conductive agent: core-in-sheath structure (FIG. 10)

Arrangement of brush fibers: obliquely provided (FIG. 15A)

Diameter of the brush roller: 14 mm

Resistance of brush original yarn: 10⁸ μ·cm

Brush fiber density: 100,000/inch² (1 inch=0.0254 m)

Intrusion amount with respect to photoconductor drum: 1 mm

### Recovering Roller 6B1:

Material: metal core: SUS

Intermediate layer: PVDF tube (100 μm)

Surface layer: acrylic coat (10 μm)

Diameter of the recovering roller: 12 mm

Intrusion amount with respect to brush fibers: 1 mm

### Recovering Roller Cleaning Blade 6B2:

Material: dispersion of conductive agent in polyurethane rubber

Angle at which the blade comes into contact with the roller: 20°

Intrusion amount with respect to recovering roller: 1 mm

### Voltages Applied:

Power source 60: +250 V

Power source 61: +650 V

Power source 60′: −450 V

Power source 61′: −800 V

Power source 62′: −1,950 V

The voltage may be appropriately adjusted in consideration of the linear velocity of the recovering roller, and a temperature and humidity in the environmental conditions.

Also, as shown in FIG. 20, the member 63 may be provided for supplying charges to the tips of the brush fibers of the second brush roller, or of both the first and second brush rollers.

### Example 6

The configuration of this Example is characterized in that the recovering roller cleaning blade is a metal blade.

In this Example, a recovering roller cleaning blade made of metal is brought into contact with the recovering roller to remove toner particles present thereon. For example, the metal blade is an SUS plate having a thickness of 0.08 mm, and disposed so as to intrude the recovering roller by about 0.8 mm.

As shown in the above Examples, in the present invention, the recovering roller is given a voltage to generate an electrical potential between the brush roller and the recovering roller, and toner particles remaining on the brush roller are electrically adsorbed on the recovering roller utilizing the electrical potential.

Here, the reason why a voltage is applied to the recovering roller having an insulative layer is described below by comparing the case where the recovering roller is given a voltage with the case where the recovering roller is not given a voltage.

As described above based on the principle of electrostatic cleaning, in the present invention, remaining toner particles are transferred from the brush roller to the recovering roller utilizing an electrical potential difference therebetween. Thus, even a recovering roller having an insulative surface must maintain to have a sufficient electrical potential to electrostatically adsorb remaining toner particles on the surface.

Next will be described an experiment on change in surface potential of the recovering roller having an insulative surface layer when a voltage is applied thereto, and an experiment on change in surface potential of the recovering roller having an insulative surface layer when no voltage is applied thereto.

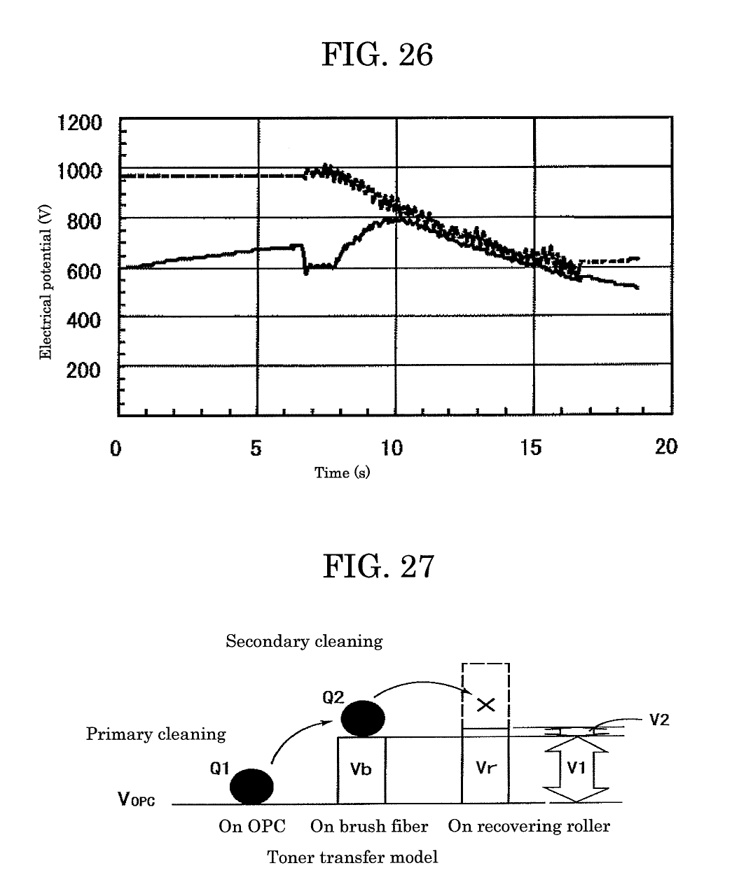

FIG. 25 illustrates the configuration of an experiment in which no charges are supplied to a surface of the recovering roller having an insulative surface layer (denoted by reference character 6B1, for the sake of convenience). As a result of the experiment, the surface electrical potential of the recovering roller 6B1 was changed as shown in FIG. 26. In this figure, about 10 sec after, an electrical potential difference is about 30 V between brush fiber tips and a recovering roller surface. A toner transfer model made based on the graph in this figure is shown in FIG. 27. This model indicates that there was not obtained an electrical potential difference sufficient for the recovering roller to electrically adsorb toner particles. Notably, the surface electrical potential was measured with a surface potentiometer (Model 344, product of Trek Co.), and recorded with a recorder (NR-2000, product of KEYENCE CORPORATION).

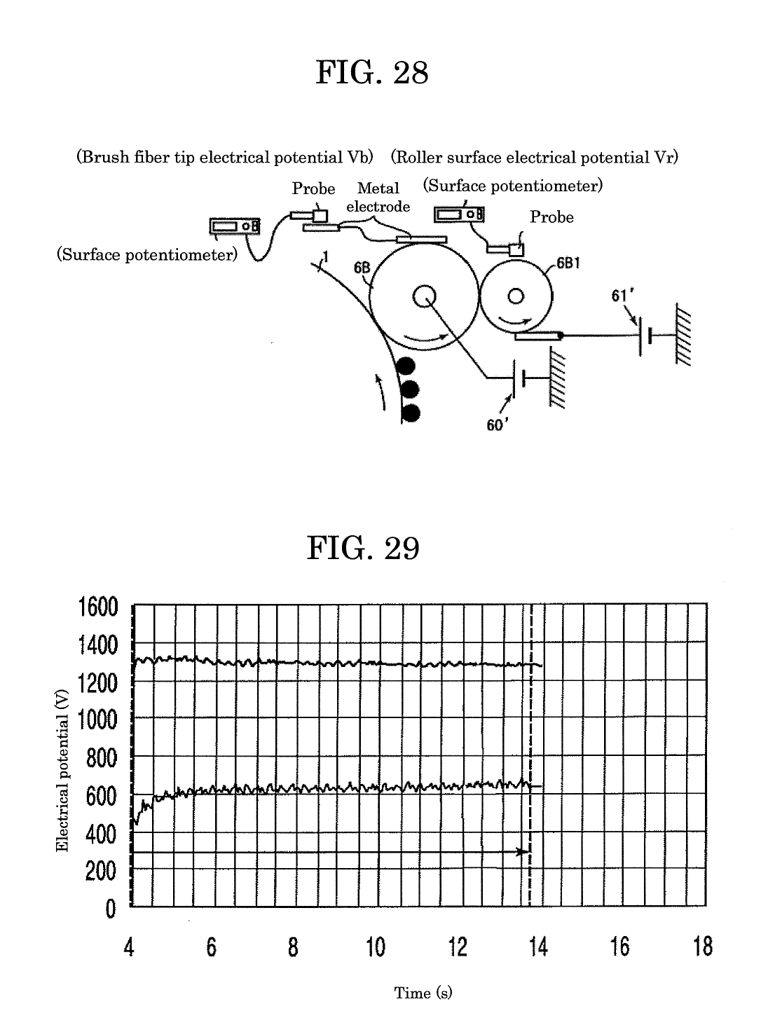

FIG. 28 illustrates the configuration of an experiment in which charges are supplied to a surface of the recovering roller 6B1 having an insulative surface layer. As a result of the experiment, the surface electrical potential of the recovering roller 6B1 was changed as shown in FIG. 29.

As is clear from the graph shown in FIG. 26, the surface potential of the recovering roller 6B1 decreased over time. In contrast, as is clear from the graph shown in FIG. 29, the surface potential of the recovering roller 6B1 remained unchanged even as time passed. A toner transfer model made based on the graph in FIG. 29 is shown in FIG. 39. This model is an ideal model based on the principle of electrostatic cleaning.

The above-obtained data indicate that charges must be supplied to the recovering roller having an insulative surface.

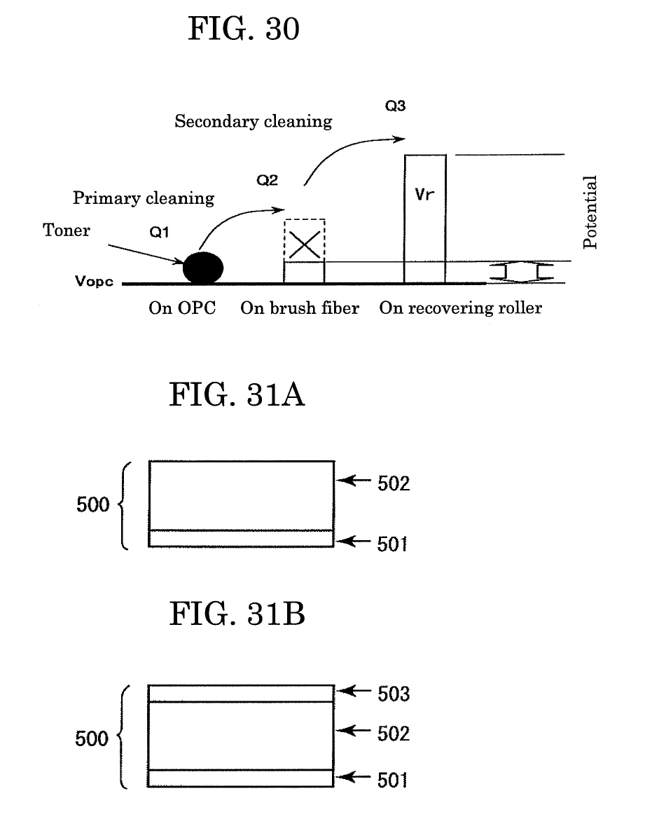

Similar to the case of the recovering roller having an insulative surface, charges must be supplied to the brush roller having looped brush fibers whose conductive agent is not exposed on surfaces thereof. FIG. 30 shows a toner transfer model corresponding to the case where no charges are supplied to the brush roller having looped brush fibers.

As is clear from this figure, the brush fiber tips to which charges are not supplied decrease in electrical potential, resulting in that toner particles cannot be transferred from the photoconductor to the brush roller. In addition, the brush roller cannot sufficiently inject charges into non-charged toner particles.

Next will be described characteristics of a photoconductor serving as an image bearing member which constitutes an image forming apparatus employing a cleaning device with the above-described configuration.

The photoconductor used in electrophotographic image formation in the present invention is an amorphous silicon photoconductor (hereinafter may be referred to as an “a-Si photoconductor”) having a conductive support and a photoconductive layer made of amorphous silicon (a-Si). The amorphous silicon photoconductor is produced by forming, on the conductive support heated at 50° C. to 400° C., the photoconductive layer through film formation such as vacuum vapor deposition, sputtering, ion plating, thermal CVD, photo-CVD or plasma CVD. Of these, preferably used is plasma CVD in which raw material gas is decomposed through DC, high-frequency or microwave glow discharge to form an a-Si deposition film on the support.

### Regarding Layer Structure

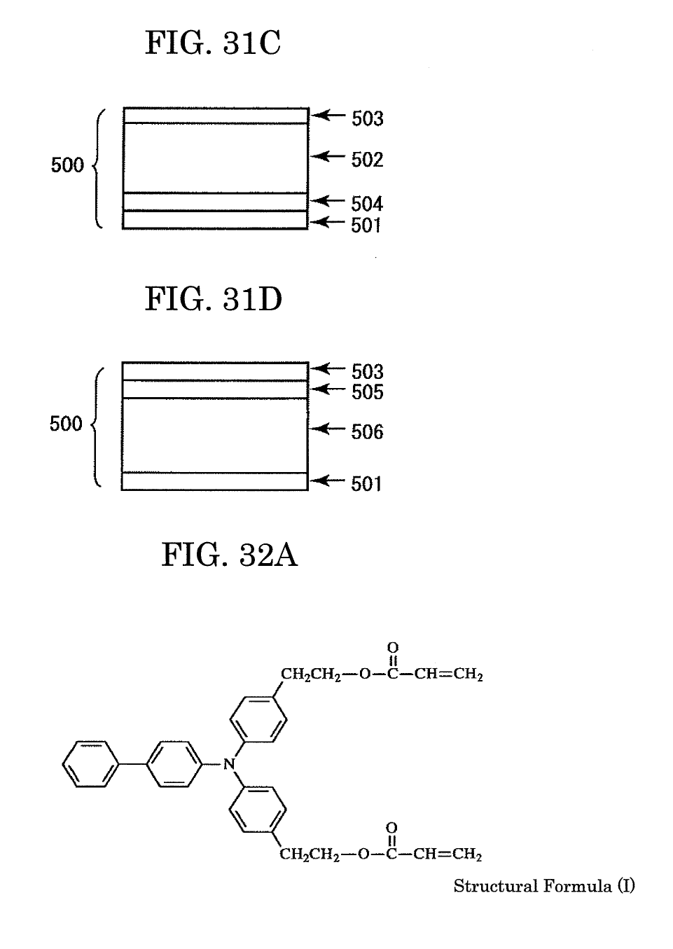

The layer structure of the amorphous silicon photoconductor is, for example, that described below. FIGS. 31A to 31D are explanatory, schematic views of the layer structure. An electrophotographic photoconductor 500 shown in FIG. 31A has a support 501 and a photoconductive layer 502 made of a-Si:H,X, the photoconductive layer being laid on the support. In a-Si:H,X, H denotes a hydrogen atom and X denotes a halogen atom (F, Cl, Br or I).

A photoconductor 500 shown in FIG. 31B has a support 501, a photoconductive layer 502 made of a-Si:H,X, and an amorphous silicon-based surface layer 503, these layers being laid on the support.

A photoconductor 500 shown in FIG. 31C has a support 501, a photoconductive layer 502 made of a-Si:H,X, an amorphous silicon-based surface layer 503, and an amorphous silicon-based charge injection preventing layer 504, these layers being laid on the support. A photoconductor 500 shown in FIG. 31D has a support 501, a photoconductive layer 502 (a charge generation layer 505 made of a-Si:H,X+a charge transport layer 506 made of a-Si:H,X) and an amorphous silicon-based surface layer 503, the photoconductive layer and the amorphous silicon-based surface layer being laid on the support in this order.

### Regarding Support

The support of the photoconductor may be conductive or electrically insulative. The conductive support is made, for example, of a metal such as Al, Cr, Mo, Au, In, Nb, Te, V, Ti, Pt, Pd or Fe; and an alloy thereof (e.g., stainless steel). Also, there may be used an electrically insulating support (e.g., glass, ceramic and films or sheets of synthetic resin such as polyester, polyethylene, polycarbonate, cellulose acetate, polypropylene, polyvinyl chloride, polystyrene or polyamide) in which at least a surface on which a conductive layer is to be laid has been subjected to a conductive treatment.

The support may be a cylindrical, plate-like or endless belt support having a smooth or surface or irregular surface. The thickness of the support is appropriately determined so that an intended image forming apparatus photoconductor can be formed. When the image forming apparatus photoconductor is required to have flexibility, the support may be thin to the greatest extent possible so long as it can sufficiently exhibit its intrinsic functions. However, the thickness of the support is generally 10 μm or greater from the viewpoints of, for example, production suitability, handleability and mechanical strength.

### Regarding Charge Injection Preventing Layer

In the amorphous silicon photoconductor used in the present invention, the charge injection preventing layer, which prevents charges from being injected from the conductive support, is effectively provided between the conductive support and the photoconductive layer in accordance with needs (see FIG. 31C).

The charge injection preventing layer has a so-called polarity dependency; i.e., has the function of preventing injection of charges from a support to a photoconductive layer which has been positively (negatively) charged on its free surface, but does not have the function of preventing injection of charges from a support to a photoconductive layer which has been negatively (positively) charged on its free surface. In order for the charge injection preventing layer to have such a function, an atom controlling conductivity is incorporated into it in a higher amount than into the photoconductive layer.

The thickness of the charge injection preventing layer is preferably 0.1 μm to 5 μm, more preferably 0.3 μm to 4 μm, optimally 0.5 μm to 3 μm, from the viewpoints of, for example, attaining desired electrophotographic characteristics and being economically advantageous.

### Regarding Photoconductive Layer

The photoconductive layer is formed on an underlying layer in accordance with needs. The thickness of the photoconductive layer 502 is determined as desired in consideration of, for example, attaining desired electrophotographic characteristics and being economically advantageous. It is preferably 1 μm to 100 μm, more preferably 20 μm to 50 μm, optimally 23 μm to 45 μm.

### Regarding Charge Transport Layer

The charge transport layer is one layer of a functionally separated photoconductive layer and mainly transports charges.

The charge transport layer contains, as a constituent component, at least a silicon atom, a carbon atom and a fluorine atom. If necessary, it is made of a-SiC(H, F, O) containing a hydrogen atom and an oxygen atom. The charge transport layer has desired photoconductive characteristics, among others, charge retaining characteristics, charge generating characteristics and charge transporting characteristics. In the present invention, it particularly preferably contains an oxygen atom.

The thickness of the charge transport layer is determined as desired in consideration of, for example, attaining desired electrophotographic characteristics and being economically advantageous. It is preferably 5 μm to 50 μm, more preferably 10 μm to 40 μm, optimally 20 μm to 30 μm.

### Regarding Charge Generation Layer

The charge generation layer is one layer of a functionally separated photoconductive layer and mainly generates charges.

The charge generation layer contains, as a constituent component, at least an Si atom but does not substantially contain a carbon atom. If necessary, it is made of a-Si:H containing a hydrogen atom. The charge generation layer has desired photoconductive characteristics, among others, charge generating characteristics and charge transporting characteristics.

The thickness of the charge generation layer is determined as desired in consideration of, for example, attaining desired electrophotographic characteristics and being economically advantageous. It is preferably 0.5 μm to 15 μm, more preferably 1 μm to 10 μm, optimally 1 μm to 5 μm.

### Regarding Surface Layer

In the amorphous silicon photoconductor of the present invention, if necessary, the surface layer may be further provided on the photoconductive layer formed on the support as described above. Preferably, an amorphous silicon-based surface layer is formed. The surface layer has a free surface and is provided for the purpose of desirably attaining, among others, humidity resistance, durability to continuous, repetitive use, electric pressure resistance, resistance to environmental factors and durability, to such an extent that the objects of the present invention are achieved.

In the present invention, the thickness of the surface layer is generally 0.01 μm to 3 μm, preferably 0.05 μm to 2 μm, optimally 0.1 μm to 1 μm. When the thickness is smaller than 0.01 μm, the surface layer is lost due to, for example, ablation of the photoconductor during use. Whereas when the thickness is greater than 3 μm, electrophotographic characteristics degrade (e.g., increase in residual potential).

In addition to the above-described photoconductor, next will be described an organic photoconductor having a crosslinkable overcoat layer containing a crosslinkable charge transport material.

A protective layer having a crosslinked structure (binder) is advantageously used. The crosslinked structure is formed as follows. Specifically, reactive monomers each having a plurality of crosslinkable functional groups in one molecule are crosslinked one another through application of light or heat energy to form a three-dimensional network structure. The thus-formed network structure has the function of a binder resin, and exhibits high ablation resistance.

In terms of electrical stability, printing durability and service life, advantageously, all or part of the reactive monomers have charge transportability. Use of such monomers forms a charge transport site(s) in the network structure, allowing the formed protective layer to sufficiently exhibit its functions.

Examples of the reactive monomers having charge transportability include compounds, in one molecule, containing at least one charge transportable moiety and at least one silicon atom having a hydrolizable substituent; compounds, in one molecule, a charge transportable moiety and a hydroxyl group; compounds, in one molecule, a charge transportable moiety and a carboxyl group; compounds, in one molecule, a charge transportable moiety and an epoxy group; and compounds, in one molecule, a charge transportable moiety and an isocyanate group. These may be used individually or in combination.

In addition, reactive monomers having a triarylamine structure are advantageously used, from the viewpoints of exhibiting a high electrical/chemical stability, a high carrier mobility, etc.

In addition, a mono- or di-functional polymerizable monomer or oligomer can be used in combination, for the purposes of, for example, adjusting the viscosity of a coating liquid, relaxing the stress of the formed charge transport layer, decreasing the surface energy thereof, and reducing the friction coefficient thereof. These polymerizable monomer or oligomer may be those known in the art.

In the present invention, a hole transport compound is polymerized or crosslinked through application of heat or light. When polymerization reaction is performed through application of heat, there is a case where it proceeds only through application of heat energy and a case where it additionally requires a polymerization initiator for proceeding. Preferably, the polymerization initiator is added to the reaction system for allowing the reaction to efficiently proceed at a lower temperature.

When polymerization reaction is performed through application of light, a UV light is preferably employed. But, polymerization reaction rarely proceeds only through application of light energy and thus, a photopolymerization initiator is generally used in combination.

The polymerization initiator used is those which absorb, among others, a UV light with a wavelength of 400 nm or less to generate active species (e.g., radicals and ions) and then initiate polymerization. In the present invention, such a photopolymerization initiator is used in combination with heat.

The charge transport layer having such a network structure exhibits high ablation resistance. But, formation of the charge transport layer through crosslinking reaction involves considerable volume shrinkage. Thus, when the coating liquid therefor is coated to form a thick layer, the formed charge transport layer may have cracking, etc. In this case, a laminated protective layer may be formed whose lower layer (nearer the photoconductive layer) is made of low molecular weight dispersion polymer and whose upper layer (nearer the surface) has a crosslinked structure.

### <Electrophotographic Photoconductor A>

Methyltrimethoxysilane (182 parts), dihydroxymethyltriphenylamine (40 parts), 2-propanol (225 parts), 2% by mass acetic acid (106 parts) and aluminum triacetylacetonate (1 part) were mixed with one another, to thereby prepare a protective layer-coating liquid. The thus-prepared coating liquid was applied and dried on the charge transport layer, followed by thermal curing at 110° C. for 1 hour, to thereby form a protective layer having a thickness of 5 μm.

### <Electrophotographic Photoconductor B>

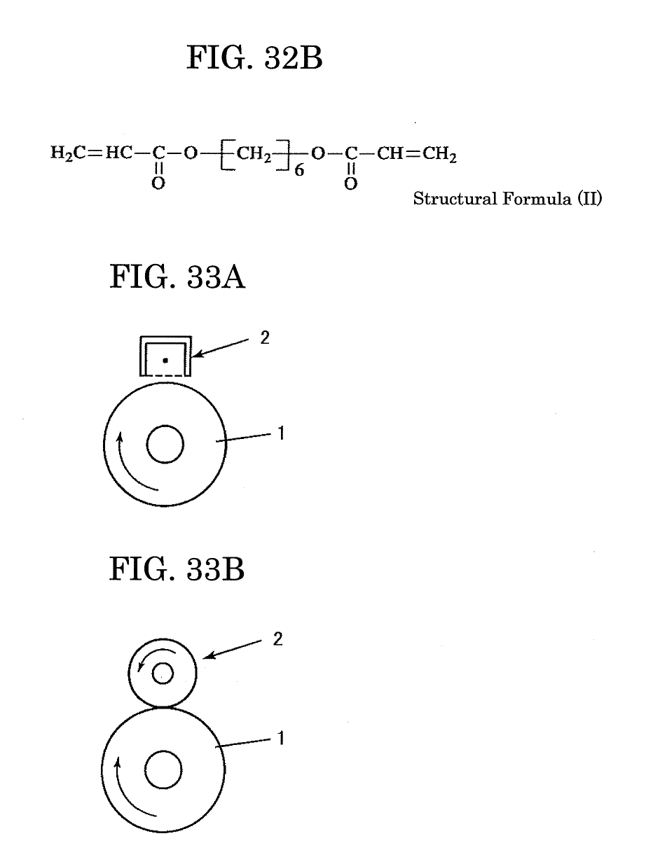

A hole transport compound having structural formula (I) shown in FIG. 32A (30 parts), an acrylic monomer having structural formula (II) shown in FIG. 32B, and a photopolymerization initiator (1-hydroxy-cyclohexyl-phenyl-ketone) (0.6 parts) were dissolved in a solvent mixture of monochlorobenzene (50 parts) and dichloromethane (50 parts), to thereby prepare a surface protective layer-coating liquid. The thus-prepared coating liquid was applied onto the charge transport layer through spray coating, followed by curing for 30 sec at a light intensity of 500 mW/cm² with a metal halide lamp, to thereby form a surface protective layer having a thickness of 5 μm.

The protective layer of the photoconductor contains a filler for improving its ablation resistance.

Examples of the filler include organic fillers such as fluorine resin powder (e.g., polytetrafluoroethylene powder), silicone resin powder and α-carbon powder; inorganic fillers such as powders of metals (e.g., copper, tin, aluminum and indium), metal oxides (e.g., tin oxide, zinc oxide, titanium oxide, indium oxide, antimony oxide, bismuth oxide, tin oxide doped with antimony, and indium oxide doped with tin); and inorganic materials (e.g., potassium titanate). These fillers may be used individually or in combination, and may be dispersed in a protective layer coating liquid using an appropriate disperser. The filler preferably has an average particle diameter of 0.5 μm or lower, preferably 0.2 μm or lower, in consideration of transmittance of a protective layer formed. Furthermore, in the present invention, a plasticizer and/or a leveling agent may be incorporated into the protective layer 21.

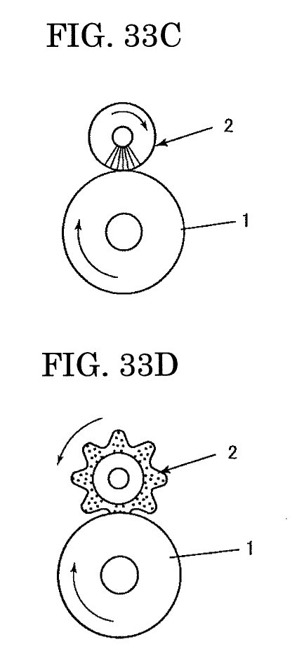

Notably, the charging unit 2 used in the embodiments of the present invention may be that illustrated in FIG. 33A, 33B, 33C or 33D.

Here, FIG. 33A illustrates a charging unit employing a corona charger. FIG. 33B illustrates a charging roller disposed proximately to the photoconductor drum 1. FIG. 33C illustrates a charging unit configured to have a charging brush which injects charges into the photoconductor drum 1 with being brought into contact with the photoconductor drum. FIG. 33D illustrates a charging unit configured to bring charged particles into contact with the photoconductor drum 1.

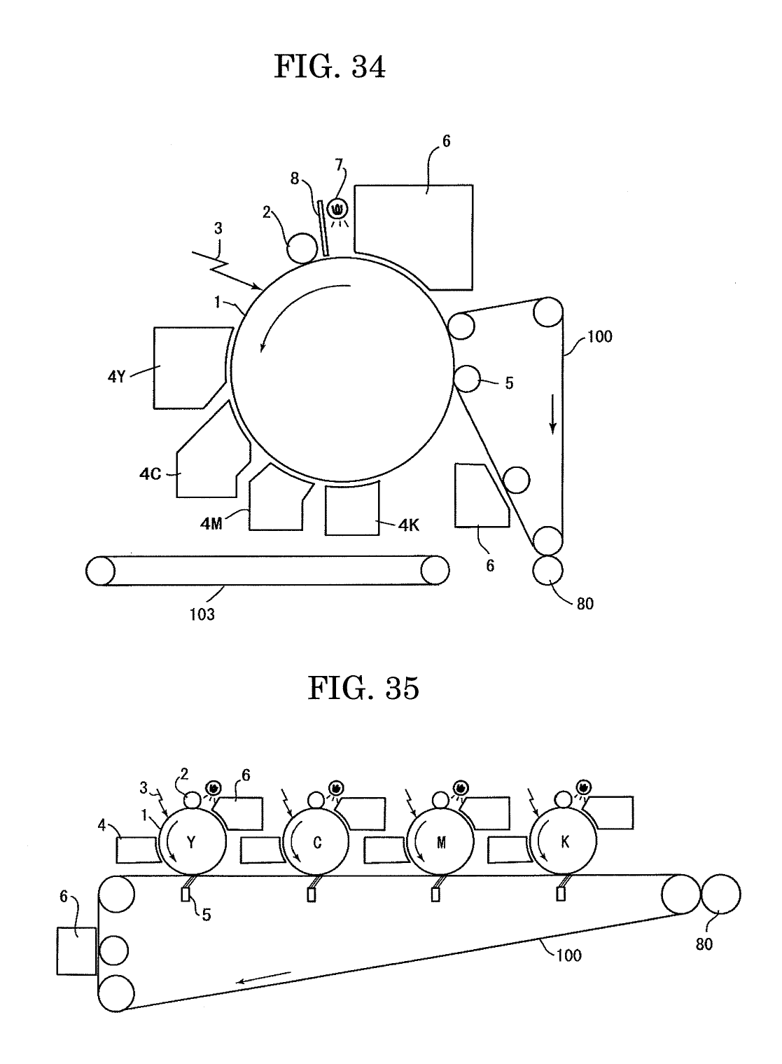

In the present embodiment, the photoconductor drum is exemplified as the image bearing member which is a member to be cleaned. In the present invention, other image bearing members than the photoconductor drum can be cleaned. An image forming apparatus shown in FIG. 34 in which a plurality of developing devices 4Y, 4C, 4M and 4K are disposed around one photoconductor drum 1 to achieve multi-color image formation, a cleaning device 6 may be provided so as to clean an intermediate transfer belt 100 onto which images sequentially formed on the photoconductor drum 1 are primarily transferred, and may be provided so as to clean the photoconductor drum 1. Notably, in FIG. 34, reference numeral 80 denotes a secondary transfer device which is used for transferring a superposed image at one time, and reference numeral 103 denotes a belt for conveying a recording paper.

Also, another image forming apparatus using a belt is a tandem image forming apparatus shown in FIG. 35 in which image forming sections for color toners (denoted by reference characters Y, C, M and K, for the sake of convenience) are disposed in a row on a tightly stretched surface of an intermediate transfer belt 100. Each image forming section of the image forming apparatus has the members shown in FIG. 1; i.e., the photoconductor drum 1 and the members disposed therearound. In this image forming apparatus, a cleaning device 6 may be provided so as to clean the intermediate transfer belt 100 and the photoconductor drum of each image forming section.

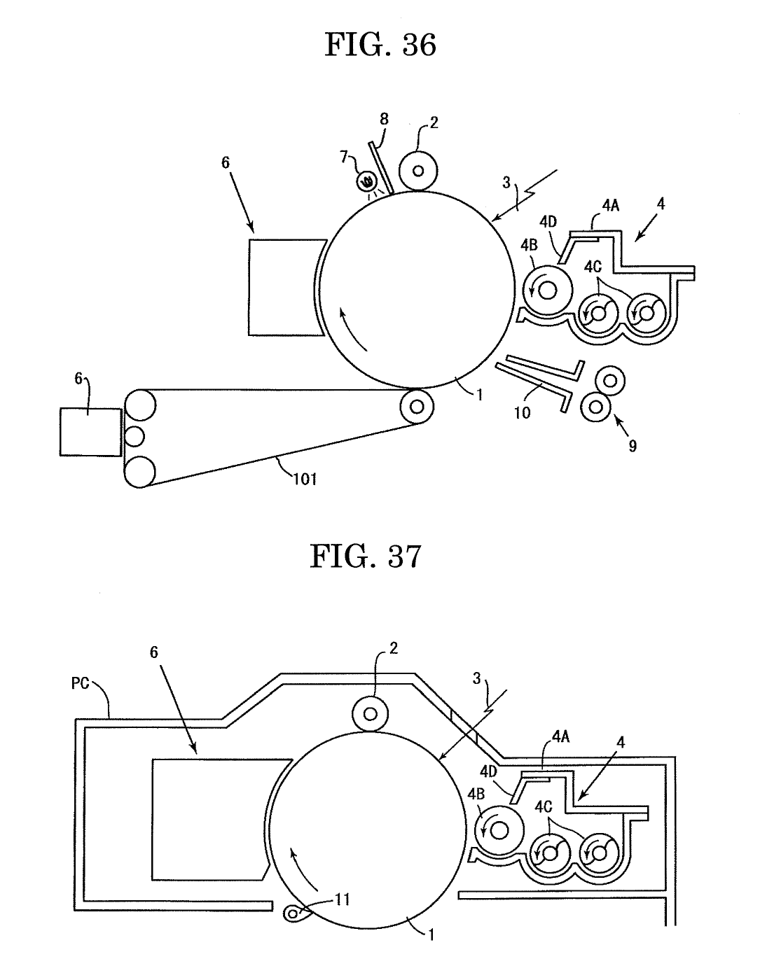

The belt in the image forming apparatus may be used not only for serving as an intermediate transfer member but also for conveying a recording paper. FIG. 36 shows an image forming apparatus whose belt is used for conveying a recording paper. In this figure, a belt 101 conveys a recording paper, and a roller located in a loop of a tightly stretched belt serves as a transfer device. In this image forming apparatus, a cleaning device 6 may be provided so as to clean the photoconductor drum 1 and the conveyor belt 101.

FIG. 37 shows a process cartridge detachably mounted as each image forming section of the tandem image forming apparatus shown in FIG. 35.

The process cartridge PC shown in FIG. 37 houses a photoconductor drum 1, a charging unit 2, a developing device 4, a cleaning device 6 and other members, which are used for image formation. In the process cartridge PC, image formation is performed similar to the case of the image forming apparatus shown in FIG. 1. The process cartridge PC is detachably mounted to the image forming apparatus and thus, maintenance and parts replacement therefor is easily performed.

What is claimed is:

1. A cleaning device used for removing toner particles remaining on an image bearing member, the cleaning device comprising:
a plurality of brush rollers capable of coming into contact with the image bearing member, the brush rollers being disposed around the image bearing member in a row in a direction in which the image bearing member is moved,
wherein one of the brush rollers comprises brush fibers each containing a conductive agent dispersed homogeneously therein or dispersed only in a surface layer thereof,
wherein another brush roller comprises oblique brush fibers, looped brush fibers, or both the oblique brush fibers and the looped brush fibers, each brush fiber containing the conductive agent localized in a center portion thereof without being dispersed in a surface layer thereof, and
wherein the oblique brush fibers are obliquely provided in the another brush roller so that tip portions thereof are curled on the image bearing member in a direction in which the image bearing member is moved.

2. The cleaning device according to claim 1, wherein the another brush roller comprises the oblique brush fibers.

3. The cleaning device according to claim 1, wherein the another brush roller comprises the looped brush fibers.

4. The cleaning device according to claim 1, further comprising rollers provided respectively for the plurality of brush rollers so as to be in contact therewith, wherein the roller which is in contact with the another brush roller is provided with an insulative surface layer.

5. The cleaning device according to claim 1, wherein the toner particles remaining on the image bearing member are adjusted to have a shape factor 1 (SF-1) of 100 to 150.

6. An image forming apparatus comprising:
a cleaning device used for removing toner particles remaining on an image bearing member,
wherein the cleaning device comprises a plurality of brush rollers capable of coming into contact with the image bearing member, the brush rollers being disposed around the image bearing member in a row in a direction in which the image bearing member is moved,
wherein one of the brush rollers comprises brush fibers each containing a conductive agent dispersed homogeneously therein or dispersed only in a surface layer thereof,
wherein another brush roller comprises oblique brush fibers, looped brush fibers, or both the oblique brush fibers and the looped brush fibers, each brush fiber containing the conductive agent localized in a center portion thereof without being dispersed in a surface layer thereof, and
wherein the oblique brush fibers are obliquely provided in the another brush roller so that tip portions thereof are curled on the image bearing member in a direction in which the image bearing member is moved.

7. The image forming apparatus according to claim 6, further comprising photoconductors and image forming sections capable of forming images of different colors, the photoconductors being provided respectively in the image forming sections, wherein the cleaning device is provided for each of the photoconductors.

8. The image forming apparatus according to claim 6, further comprising an intermediate transfer member and image forming sections capable of forming images of different colors, wherein the images formed in the image forming sections are sequentially transferred onto the intermediate transfer member, and wherein the cleaning device is provided for the intermediate transfer member.

9. The image forming apparatus according to claim 6, further comprising a belt member and image forming sections capable of forming images of different colors, the image forming sections being provided around the belt member, wherein the belt member conveys a recording medium to the image forming sections, and wherein the cleaning device is provided for the belt member.

10. The image forming apparatus according to claim 7, wherein each of the photoconductors comprises a filler dispersed therein.

11. The image forming apparatus according to claim 7, wherein each of the photoconductors is an organic photoconductor having a surface layer reinforced with a filling agent, an organic photoconductor containing a crosslinkable charge transport material, or a photoconductor having a surface layer reinforced with a filling agent and containing a crosslinkable charge transport material.

12. The image forming apparatus according to claim 7, wherein the photoconductors are an amorphous silicon photoconductor.

13. The image forming apparatus according to claim 6, further comprising a process cartridge and a photoconductor serving as the image bearing member, wherein the process cartridge integrally houses any of the photoconductor, a charging unit, a developing unit and the cleaning device, and wherein the charging unit, the developing unit and the cleaning device are used for image forming processing with respect to the photoconductor.

14. The image forming apparatus according to claim 6, wherein the cleaning device further comprises a recovering roller capable of coming into contact with the brush rollers, and a blade which is provided so as to be in contact with the recovering roller and to scrape off the toner particles thereon, and wherein the blade is provided with a coating layer having ablation resistance at an edge surface where the blade is in contact with the recovering roller.
